(19) United States
(12) Patent Application Publication
(10) Pub. No.: US 2024/0114449 A1
(43) Pub. Date: Apr. 4, 2024

(54) MUTUAL SUPPORT AND OPERATION OF MAIN RADIO AND LOW-POWER WAKEUP RADIO

(71) Applicant: QUALCOMM Incorporated, San Diego, CA (US)

(72) Inventors: Ahmed ELSHAFIE, San Diego, CA (US); Hung Dinh LY, San Diego, CA (US); Huilin XU, Temecula, CA (US); Wanshi CHEN, San Diego, CA (US); Changhwan PARK, San Diego, CA (US); Linhai HE, San Diego, CA (US); Yuchul KIM, San Diego, CA (US); Wei YANG, San Diego, CA (US); Peter GAAL, San Diego, CA (US); Le LIU, San Jose, CA (US); Diana MAAMARI, San Diego, CA (US)

(21) Appl. No.: 17/936,727

(22) Filed: Sep. 29, 2022

(51) Int. Cl. H04W 52/02

(52) U.S. Cl. CPC H04W 52/0225

(57) ABSTRACT

A network node may transmit a first signal to a first radio at a user equipment (UE). The UE may receive the first signal from the network node. The first signal may include a first configuration for a second radio at the UE. The UE may operate the second radio in a first mode based on the first configuration received via the first radio. The first radio may have a lower power consumption than the second radio or the second radio may have the lower power consumption than the first radio. For example, one radio may be a low-power wake-up radio (LP-WUR) having a lower power consumption than a main radio (MR) at the UE. The network node and the UE may communicate with one another via the second radio at the UE based on the first configuration transmitted to the first radio.

### TECHNICAL FIELD

The present disclosure relates generally to communication systems, and more particularly, to a wireless system that supports a first radio that has a first power consumption and a second radio that has a second power consumption different than the first radio.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may receive a first signal including a first configuration using a first radio at the UE. The apparatus may operate a second radio at the UE in a first mode based on the first configuration received via the first radio. The first radio may have a lower power consumption than the second radio or the second radio may have the lower power consumption than the first radio. For example, one radio may be a low-power wake-up radio (LP-WUR) having a lower power consumption than a main radio (MR) of the UE.

In an aspect of the disclosure, a method, a computer-readable medium, and an apparatus at a network node are provided. The apparatus may transmit a first signal including a first configuration for a second radio to a first radio at a UE. The apparatus may communicate with the second radio at the UE based on the first configuration transmitted to the first radio. The first radio has a lower power consumption than the second radio or the second radio has the lower power consumption than the first radio. For example, one radio may be an LP-WUR having a lower power consumption than an MR of the UE.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A is a diagram illustrating an example of a first UE configured to communicate with a network node and/or a second UE using one of two radios, in accordance with various aspects of the present disclosure.

FIG. 4B is a diagram illustrating an example of a first UE configured to communicate with a network node and/or a second UE using two radios, in accordance with various aspects of the present disclosure.

FIG. 5 is a communication flow diagram illustrating an example of a UE configured to communicate with a network node using two radios, in accordance with various aspects of the present disclosure.

FIG. 6 is a communication flow diagram illustrating an example of a first UE configured to communicate with a network node and/or a second UE using two radios, in accordance with various aspects of the present disclosure.

FIG. 7 is a diagram illustrating an example of a transmission schedule between a UE and a network node, in accordance with various aspects of the present disclosure.

FIG. 8 is a flowchart of a method of wireless communication.

FIG. 9 is a flowchart of a method of wireless communication.

FIG. 10 is a flowchart of a method of wireless communication.

FIG. 11 is a flowchart of a method of wireless communication.

FIG. 12 is a diagram illustrating an example of a hardware implementation for an example apparatus and/or network entity.

FIG. 13 is a diagram illustrating an example of a hardware implementation for an example network entity.

FIG. 14 is a diagram illustrating an example of a hardware implementation for an example network entity.

### DETAILED DESCRIPTION

A user equipment (UE) may have two or more radios having different levels of power consumption, such as a first radio at the UE that consumes less power than a second radio at the UE. The first radio may be, for example, a low-power (LP) wake-up radio (LP-WUR). The second radio may be, for example, a main radio (MR). The radio having a higher power consumption may also be referred to as a high-power radio (HPR). The radio having a lower power consumption may also be referred to as a low-power radio (LPR). While the UE may save power by offloading some operations from the HPR to the LPR, the LPR may have limited functionality as compared with the HPR. While the UE may save time by operating both the HPR and the LPR simultaneously, if the UE is configured to operate two radios simultaneously, the radios may interfere with one another. There is a need for optimizing use of a UE having two or more radios. In some aspects, a signal transmitted to one radio may be used to configure an operation, such as a transmit signal operation, a receive signal operation, a wake-up operation (changing a state of the radio from a sleep mode to an active mode), or a sleep operation (changing a state of the radio from an active mode to a sleep mode).

In some aspects, a network node may transmit a first signal to a first radio at a UE. The UE may receive the first signal from the network node at the first radio. The first signal may include a first configuration for a second radio at the UE. The UE may operate the second radio in a first mode based on the first configuration received via the first radio. The first radio may have a lower power consumption than the second radio or the second radio may have the lower power consumption than the first radio. For example, one radio may be an LP-WUR having a lower power consumption than a MR at the UE. The network node and the UE may communicate with one another via the second radio at the UE based on the first configuration transmitted to the first radio. In some aspects, the UE may have limited functionality at the radio having the lower power consumption. For example, the LPR may be configured to be limited to transmitting a schedule request (SR) for communication at the HPR or the LPR, transmitting hybrid automatic repeat request (HARQ) acknowledgment (ACK) (HARQ-ACK) feedback for data received by the HPR or the LPR, transmitting channel state information (CSI) feedback for downlink (DL) communication at the HPR, receiving a DL scheduling grant to transmit (Tx) data at the HPR, and/or receiving an uplink (UL) scheduling grant to receive (Rx) data at the HPR. In some aspects, the UE may be configured to minimize interference between the HPR and the LPR, for example by scheduling the radios to use different resources, resource sets, bands, or sub-bands, or by using time domain multiplexing (TDM) to operate the HPR and the LPR during a time period when both the HPR and the LPR may be scheduled to operate.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media may include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be acces sed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

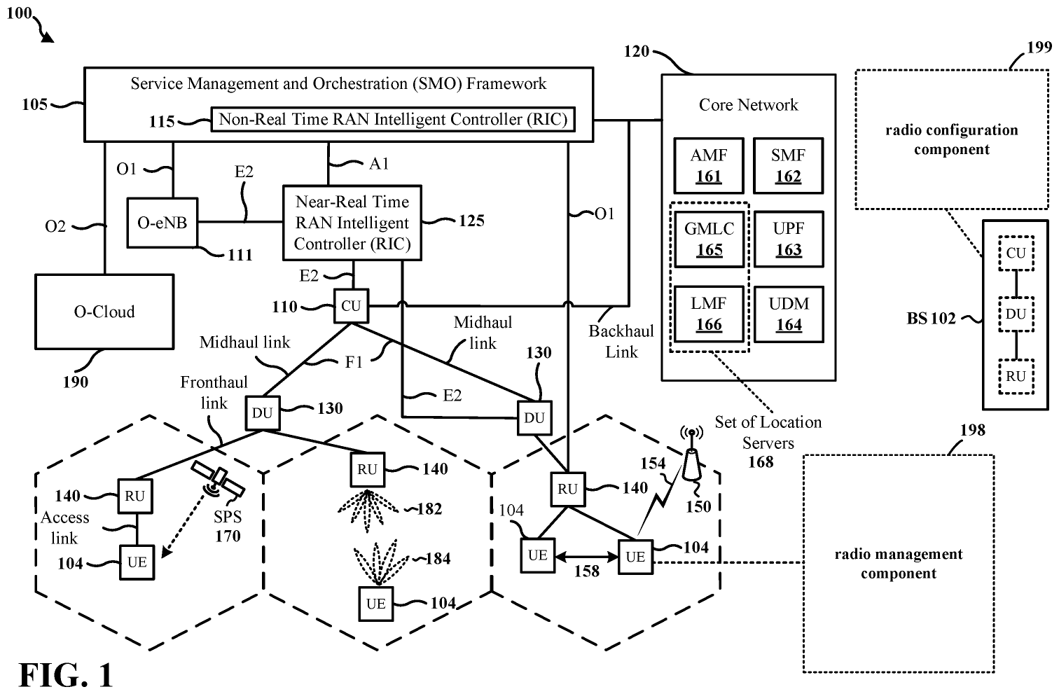

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmission reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a radio management component 198 configured to receive a first signal including a first configuration using a first radio at the UE. The radio management component 198 may be configured to operate a second radio at the UE in a first mode based on the first configuration received via the first radio. The first radio may have a lower power consumption than the second radio or the second radio may have the lower power consumption than the first radio. In certain aspects, the base station 102 may have a radio configuration component 199 configured to transmit a first signal including a first configuration for a second radio to a first radio at a UE. The radio configuration component 99 may be configured to communicate with the second radio at the UE based on the first configuration transmitted to the first radio. The first radio may have a lower power consumption than the second radio or the second radio may have the lower power consumption than the first radio. Although the following description may be focused on systems that communicate with UEs having a main radio (MR) and a low-power (LP) wake-up radio, the concepts described herein may be applicable to systems that communicate with any UE having a plurality of radios, where one radio may have less components, functionality, or power consumption than the other radio. Although the following description may be focused on 5G NR, the concepts described herein may be applicable to other similar areas, such as LTE, LTE-A, CDMA, GSM, and other wireless technologies.

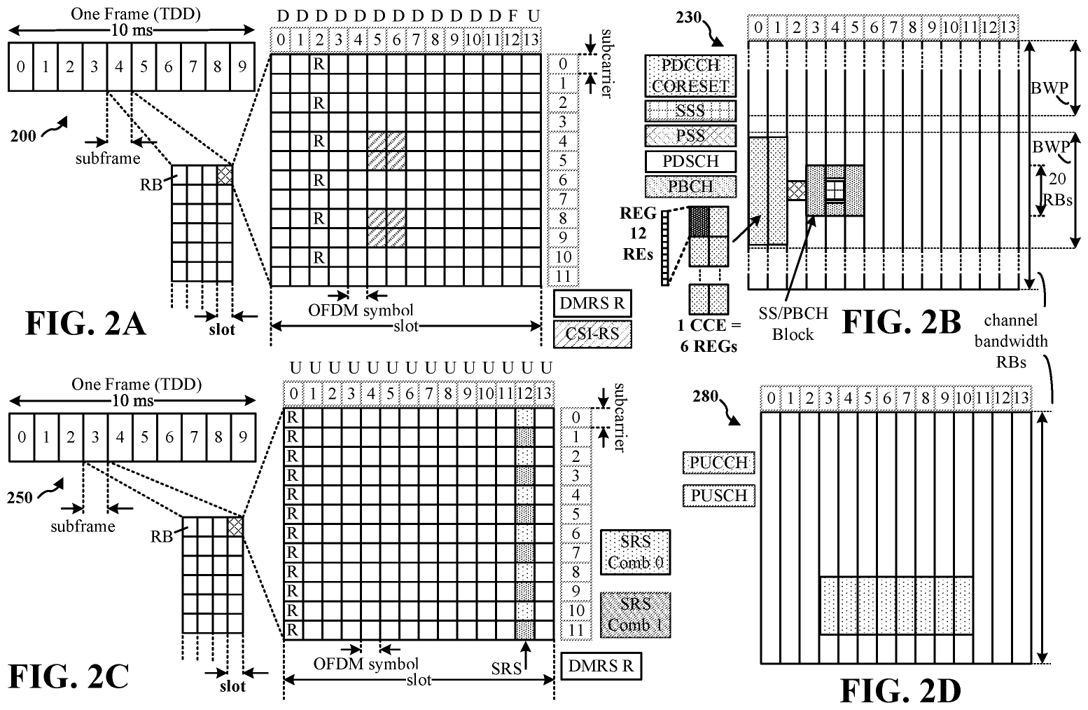

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology 1.1=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIB s), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

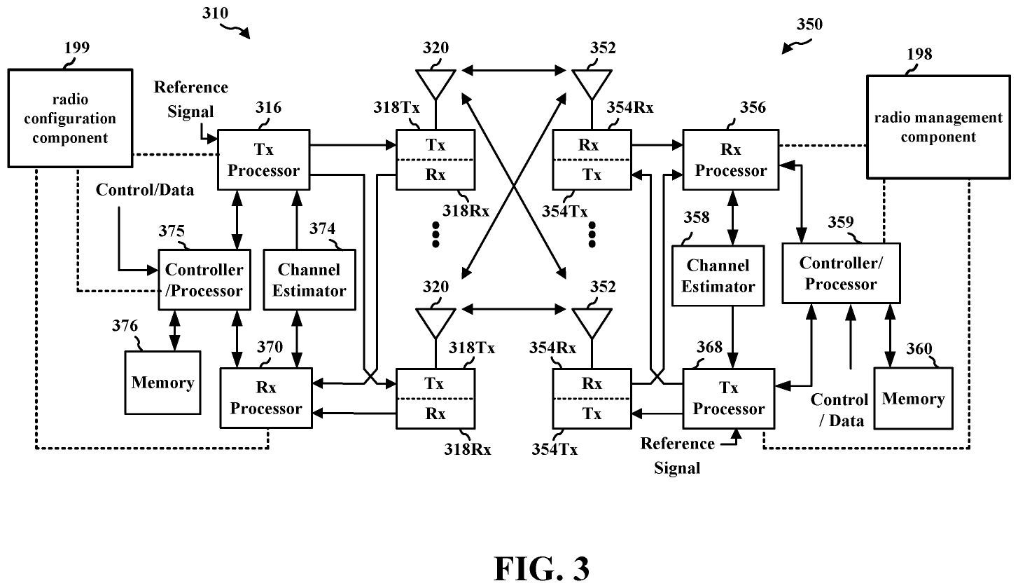

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIB s), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (Tx) processor 316 and the receive (Rx) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The Tx processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (Rx) processor 356. The Tx processor 368 and the Rx processor 356 implement layer 1 functionality associated with various signal processing functions. The Rx processor 356 may perform spatial processing on the information to recover any spatial streams destined for the UE 350. If multiple spatial streams are destined for the UE 350, they may be combined by the Rx processor 356 into a single OFDM symbol stream. The Rx processor 356 then converts the OFDM symbol stream from the time-domain to the frequency domain using a Fast Fourier Transform (FFT). The frequency domain signal may include a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIB s) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the Tx processor 368 to select the appropriate coding and modulation schemes, and to facilitate spatial processing. The spatial streams generated by the Tx processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a Rx processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the Tx processor 368, the Rx processor 356, and the controller/processor 359 may be configured to perform aspects in connection with the radio management component 198 of FIG. 1.

At least one of the Tx processor 316, the Rx processor 370, and the controller/processor 375 may be configured to perform aspects in connection with the radio configuration component 199 of FIG. 1.

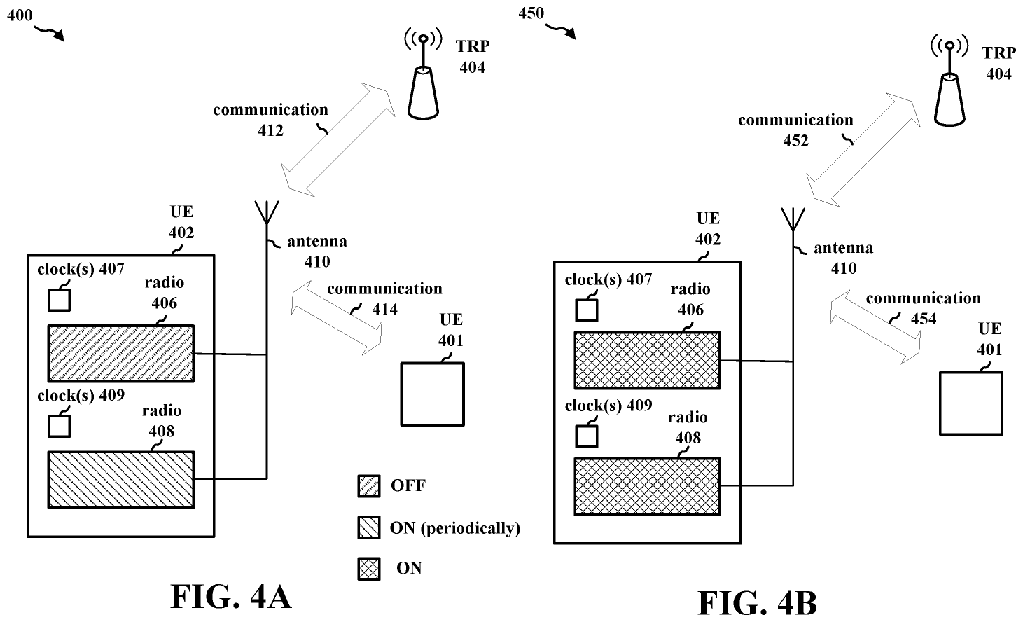

FIG. 4A is a diagram 400 illustrating an example of a UE 402 that may be configured to communicate with a TRP 404 and/or or a UE 401 using a radio 408. The UE 402 may have at least two radios—the radio 406, which is shown as being in an OFF mode, or a sleep mode, and the radio 408, which is shown as being in a periodically ON mode, or a periodically active mode. The radio 406 and the radio 408 may share the same antenna 410. In some aspects, the radio 406 and the radio 408 may use different antennas. The radio 408 may have a lower power consumption than the radio 406. In other words, the UE 402 may consume more power when the radio 408 in in an active mode and the radio 406 is in a sleep mode than when the radio 406 is in an active mode and the radio 408 is in a sleep mode. The radio 406 may be a main radio (MR) of the UE 402. The radio 406 may also be referred to as a high-power radio (HPR). The radio 408 may be a low-power (LP) wake-up radio (LP-WUR) of the UE 402. The LP-WUR may have the capability to both transmit and receive wireless signals. The radio 408 may be a passive internet of things (IoT) device. The radio 408 may be a backscatter-based radio. The radio 408 may be a radio frequency identification (RFID) tag radio. The radio 408 may also be referred to as a low-power radio (LPR) of the UE 402. The radio 408 may have less components, or less functionality, than the radio 406, resulting in the radio 408 having a lower power consumption than the radio 406. In some aspects, components of the radio 408 (e.g., an actuator, a tracking module, a sensing module) may use less power than components of the radio 406, resulting in the radio 408 having a lower power consumption than the radio 406. When the radio 406 is in a sleep mode, the radio 406 may use less power when in a periodically active mode than when the radio 406 is in an active mode. In some aspects, the radio 408 may consume less power in a periodically active mode than the radio 406 consumes when the radio 406 is in a sleep mode. The radio 408 may have less sensitivity than the radio 406. The radio 408 may have less coverage (may communicate with devices in a smaller area) than the radio 406. The radio 408 may communicate in a smaller bandwidth than the radio 406. The power consumption may be measured in terms of power consumed per unit of time, for example watts per second.

In some aspects, the radio 408 may have access to different memory storage than the radio 406. For example, the radio 408 may have access to memory storage that consumes less power than the radio 406. The radio 408 may use a cache memory storage that has less capacity than the memory storage accessible to the radio 406. In some aspects, the radio 408 may have access to a decoder having less complexity than a decoder that the radio 406 has access to. In some aspects, when the radio 406 is switched to an OFF mode or a sleep mode, a set of memory storage that the radio 408 has access to and/or a set of decoders that the radio 408 has access to may also be switched to an OFF mode, or a sleep mode. The radio 408 may be unable to store a received signal or process a received signal until the set of memory storage or the set of decoders is switched to an ON mode or an active mode. If the radio 408 receives a signal while the radio 406 is in an OFF mode or a sleep mode, the radio 408 may be configured to store the signal in a memory that the radio 406 and the radio 408 has access to, allowing the signal to be decoded when the radio 406 is switched to an active mode (and a corresponding decoder is activated). The UE 402 may be configured to decode a signal stored in memory in response to receiving a LP-WUS at the radio 408.

The UE 402 may transmit and/or receive signals with the TRP 404 using the radio 408 via communication 412. The communication 412 may represent a universal mobile telecommunications system (UMTS) air interface (Uu) connection between the UE 402 and the TRP 404. The UE 402 may transmit and/or receive signals with the UE 401 using the radio 408 via communication 414. The communication 414 may represent a sidelink connection between the UE 402 and the UE 401.

In some aspects, the radio 408 may be configured to receive an LP signal, such as an LP wake-up signal (LP-WUS), an LP reference signal (LP-RS), an LP synchronization signal (LP-SS), or an LP-sync preamble signal, from a wireless device, such as the TRP 404 via communication 412 or the UE 401 via communication 414. While the radio 406 is in a sleep mode, the radio 408 may save power at the UE 402 while meeting latency standards by periodically monitoring for a wake-up indicator, such as an LP-WUS, from a wireless device, like a network node, while the radio 406 is in a low-power sleep state. In other words, the radio 408 may be a companion receiver that monitors for a wake-up signal with low power consumption while the radio 406 is in a sleep state. If the radio 408 is in a periodically active mode, the radio 408 may be in a sleep mode and may periodically awaken to monitor for an incoming LP signal, conserving power consumed by the UE 402. The radio 408 may be configured to wake up the radio 406, or switch the radio 406 to an active mode, in response to receiving a wake-up signal, for example an LP-WUS.

An LP signal may be any signal that may be received by the radio 408, for example a signal transmitted in a frequency band that the radio 408 is configured to monitor or a signal transmitted at a time that the radio 408 is configured to periodically monitor. The radio 408 may be configured to periodically monitor for an LP signal, such as an LP-WUS, a paging indicator, a LP synchronization signal (LP-SS), an LP synchronization preamble signal (LP-sync-preamble signal), or an LP reference signal (LP-RS), in accordance with a schedule, for example in accordance with a connected mode discontinuous reception (CDRX) cycle or in accordance with a configured period. The period may be configured by a network node, for example a serving cell of the UE 402, via the TRP 404. The LP-WUS may be an on-off keying (OOK) signal, a sequence-based signal, a coded signal (e.g., PDCCH-based DCI). The LP-WUS or the paging indicator may schedule an LP-RS for the radio 408 to receive. The LP-RS may be any reference signal that may be measured by the radio 408, for example a CSI-RS, a positioning reference signal (PRS), or a synchronization signal. The TRP 404 may transmit DCI, a MAC control element (MAC-CE), or an RRC configuration including an indicator of the periodic cycle to the radio 406 or the radio 408. The indicator may be used to configure the period which the radio 408 may use to periodically monitor for a LP-RS from a network node, such as the TRP 404, or from another UE, such as the UE 401, when the radio 408 is in a periodically active mode. In some aspects, the TRP 404 may transmit an RRC configuration to the radio 406 to configure the periodic cycle before the UE 402 switches the radio 406 to a sleep mode.

FIG. 4B is a diagram 450 illustrating an example of the UE 402 where the radio 406 is shown as being in an ON mode, or an active mode and the radio 408 is shown as being in an ON mode, or an active mode. The UE 402 may transmit and/or receive signals with the TRP 404 using the radio 406 via communication 452. The UE 402 may transmit and/or receive signals with the TRP 404 using the radio 408 via communication 452. The communication 452 may represent a Uu connection between the UE 402 and the TRP 404. The UE 402 may transmit and/or receive signals with the UE 401 using the radio 406 via communication 454. The UE 402 may transmit and/or receive signals with the UE 401 using the radio 408 via communication 454. The communication 454 may represent a sidelink connection between the UE 402 and the UE 401. The radio 406 in FIG. 4B may use more power in an active mode than the radio 406 in FIG. 4A uses in a sleep mode. The radio 406 may use more power in an active mode than the radio 408 uses in an active mode.

The radio 408 may keep track of time using the set of clocks 409, which may be associated with the radio 408. In some aspects, both the radio 406 and the radio 408 may use a common clock, such as the set of clocks 407 or the set of clocks 409, to adhere to a schedule. In some aspects, the radio 406 and the radio 408 may operate with different clocks. For example, the radio 406 may use the set of clocks 407 to adhere to a schedule, and the radio 408 may use the set of clocks 409 to adhere to a schedule. At least one of the set of clocks 407 and/or the set of clocks 409 may include a real-time clock (RTC) or a local oscillator (LO) clock oscillator (LO XO). In some aspects, the UE 402 may be configured to use a set of clocks in various states, for example one set of clocks when the UE 402 is in RRC connected mode, one set of clocks when the UE 402 is in RRC idle mode, one set of clocks when the UE 402 is in RRC inactive mode one set of clocks when the UE 402 is in a full power mode, one set of clocks when the UE 402 is in a low-power mode, or one set of clocks based on traffic statistics and its priority/QoS. A network may indicate to the UE 402 which set of clocks to use in each state via a configuration transmitted via the communication 412, the communication 414, the communication 452, or the communication 454.

In some aspects, a network node may transmit an RS having a clock configuration to perform time tracking, time synchronization, frequency tracking, frequency synchronization, time error estimation and correction, frequency error estimation and correction, and/or channel estimation on the set of clocks 407, the set of clocks 409, or both the set of clocks 407 and the set of clocks 409. The RS may be an RS transmitted to the radio 406 where the radio 406 is in an active mode, for example as in FIG. 4B. The RS may be an LP-RS transmitted to the radio 408 when the radio 406 is in an active mode, for example as in FIG. 4B, or when the radio 406 is in a sleep mode, for example as in FIG. 4A. In some aspects, the clock configuration of the set of clocks 407 and/or the set of clocks 409 may be indicated to the UE 402 via a MR of the UE 402, such as the radio 406, via the communication 452 of TRP 404. The clock configuration may be transmitted as the communication 452 from the TRP 404 to the UE 402 through DCI, a MAC-CE, or an RRC configuration to the radio 406. In other aspects, the clock configuration may be transmitted as the communication 412 or the communication 452 from the TRP 404 to the UE 402 to the radio 408. The UE 402 may use the RS including the clock configuration for quasi-co-location (QCL) for a channel or for a signal received by the radio 408.

The UE 402 may characterize the set of clocks 407 and/or the set of clocks 409 using one or more clock parameters, for example as a clock with a frequency drift (in terms of parts per million per second, or ppm/s) and/or a maximum frequency error (ppm). For example, the UE 402 may characterize a clock as having a frequency drift of ±0.05 ppm/s and a maximum frequency error of 2 ppm. The UE 402 may indicate one or more clock parameters of any of the set of clocks 407 and/or the set of clocks 409 to a network node. The network node may adjust a periodicity of a synchronization signal (SS) (e.g., LP-SS and/or LP-sync-preamble signal) based on the one or more clock parameters. In some aspects, the network node may group the UEs for wakeup based on their clock type or/and at least one of clock characteristics (e.g., frequency drift or maximum frequency error) during each RRC state

In some aspects, the radio 406 and the radio 408 may operate for the UE 402 in a connected state. The UE 402 may be configured to offload one or more lightweight signals (Tx/Rx) from the radio 406 to the radio 408. For example, the UE 402 may be configured to transmit HARQ-ACK feedback, scheduling requests (SRs), measurement reports, or discovery initiation signals (i.e., initiation of discovery procedures) for sidelink communication via the radio 408. The UE 402 may perform measurement via the radio 408. The UE 402 may receive or transmit mobility measurements via the radio 408. For example, the UE 402 may transmit measurements of intra-frequency radio management resources, intra-frequency radio management resources, and/or radio link management resources for a serving cell of the UE 402 or for neighbor cells of the UE 402. The TRP 404 may configure the radio 406 and/or radio 408 via a signal transmitted to the radio 406. The TRP 404 may configure the radio 406 and/or the radio 408 via a signal transmitted to the radio 408. The UE 402 may operate the radio 406 and/or the radio 408 in accordance with the configuration.

In other words, a network node may transmit a first signal to a first radio at a UE. The UE may receive the first signal from the network node. The first signal may include a first configuration for a second radio at the UE. The UE may operate the second radio in a first mode based on the first configuration received via the first radio. The first radio may have a lower power consumption than the second radio or the second radio may have the lower power consumption than the first radio. For example, one radio may be an LPR having a lower power consumption than an MR of the UE. The network node and the UE may communicate with one another via the second radio at the UE based on the first configuration transmitted to the first radio.

While diagram 400 in FIG. 4A and diagram 450 in FIG. 4B show two radios of the UE 402, the UE 402 may have any number of radios having different power consumption, functionality, or components relative to one another, which may be configured by other radios of the UE 402. The radios having different power consumption, functionality, or components relative to one another may be operated simultaneously, and may be configured to offload some wireless operations to one another.

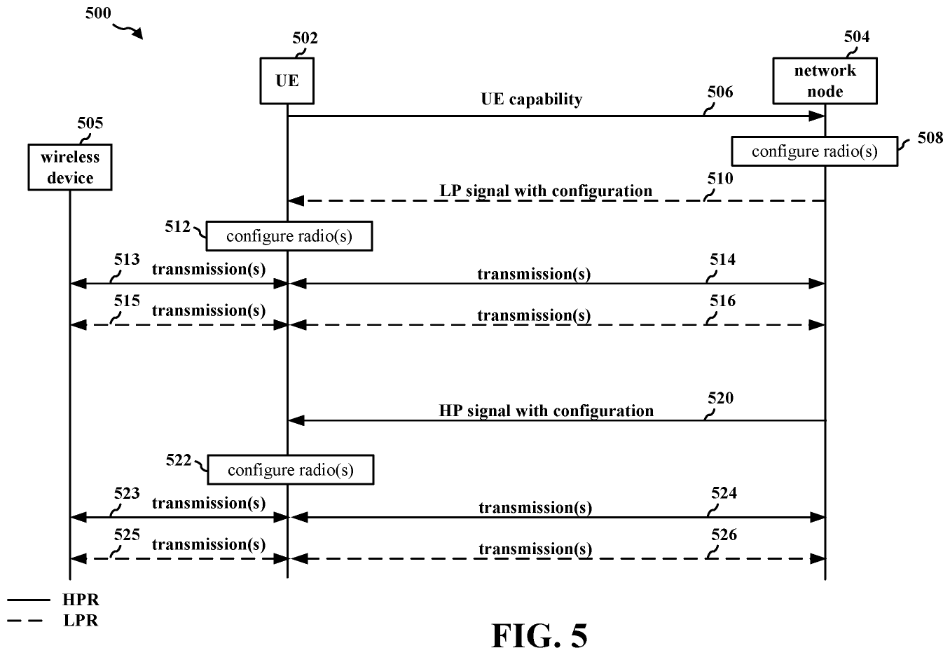

FIG. 5 is a communication flow diagram 500 illustrating a UE 502 configured to communicate with a network node 504 using a high-power radio (HPR) and/or a low-power radio (LPR). The HPR of the UE 502 may be, for example, the radio 406 in FIGS. 4A and 4B. The LPR of the UE 502 may be, for example, the radio 408 in FIGS. 4A and 4B. The LPR may have a lower power consumption than the HPR. The LPR may communicate using a different set of resources than the HPR. For example, the HPR may use a larger bandwidth than the LPR, or the HPR may use less power to transmit communications than the LPR. Communication using a set of resources associated with the HPR of the UE 502 are shown with a solid line. Communication using a set of resources associated with the LPR of the UE 502 are shown using a dotted line.

The UE 502 may transmit a UE capability 506 to the network node 504 using its HPR. The network node 504 may receive the UE capability 506 from the HPR of the UE 502. The UE capability 506 may include an indicator of a simultaneous connectivity capability of the UE 502. In other words, the UE capability 506 may indicate to the network node 504 that the UE 502 is capable of simultaneously communicating with wireless devices using its HPR and its LPR. Simultaneous communication may include operation of at least two radios at the same time during a time period (e.g., a transmission and a reception of a wireless signal at the same time, a transmission of a first wireless signal and a second wireless signal at the same time, a reception of a first wireless signal and a second wireless signal at the same time), or may include multiplexing signals of at least two radios during a time period, for example using time domain multiplexing (TDM). The UE 502 may be configured to operate a least two of its radios, such as its HPR and its LPR, at the same time during a time period by using a first set of resources at a first radio and a second set of resources at a second radio, where the first set of resources may be non-overlapping with, and non-adjacent to, the second set of resources. Sets of resources that are non-adjacent to one another may have a minimum band buffer size between the sets of resources.

Communicating with a wireless device may include transmitting a signal to the wireless device or receiving a signal from the wireless device. The indicator of the simultaneous connectivity capability may be UE specific, band specific, component carrier (CC) specific, a combination of bands, or a combination of CCs. In other words, the indicator of the simultaneous connectivity capability may indicate to the network node 504 an identifier of the UE 502, one or more bands that the UE 502 may use to communicate signals using its HPR, one or more bands that the UE 502 may use to communicate signals using its LPR, one or more CCs that the UE 502 may use to communicate signals using its HPR, and/or one or more CCs that the UE 502 may use to communicate signals using its LPR. The indicator of the simultaneous connectivity may also indicate a common set of bands or a common set of CCs that the UE 502 may use simultaneously with both its HPR and its LPR. The UE capability 506 may also include an indicator of whether the LPR of the UE 502 may communicate one or more signals that the HPR of the UE 502 may communicate, allowing the network node 504 to understand which signals may be offloaded from the HPR of the UE 502 to the LPR of the UE 502. The UE capability 506 may indicate whether the UE 502 is configured to support operation of both its HPR and its LPR simultaneously. If the UE 502 is not configured to use both its HPR and its LPR simultaneously, the UE capability 506 may have an indicator of a transition time, or a minimum time threshold, between operation of the HPR of the UE 502 and the LPR of the UE 502.

The UE capability 506 may communicate one or more clock parameters of a set of clocks associated with the UE 502, such as the set of clocks 407 and/or the set of clocks 409 in FIGS. 4A and 4B. The clock parameters may include, for example, a frequency drift (in terms of parts per million per second, or ppm/s) and/or a maximum frequency drift. For example, the UE 502 may characterize a clock as having a frequency drift of ±0.05 ppm/s and a maximum frequency drift of 2 ppm. In some aspects, the UE capability 506 may include a device type of the UE 502. For example, the UE capability 506 may include an indicator that the UE 502 is a type of smart phone or that the UE 502 is a type of RedCap device. In some aspects, the UE capability 506 may include an indicator of a type of connection that the UE 502 is capable of making. For example, the UE capability 506 may include an indicator that the UE 502 is capable of making a RedCap connection, an eRedCap connection, a Uu connection, a sidelink connection, or a non-RedCap connection. In some aspects, the UE 502 may be configured to support both a smart phone function and a RedCap function.

At 508, the network node 504 may configure the HPR of the UE 502, the LPR of the UE 502, or both the HPR and the LPR of the UE 502. A configuration may be, for example, a schedule for a communication (e.g., transmission and/or a reception) of a signal with a radio of the UE 502. The configuration may determine resources and timing for the communication, and may determine a radio for the UE 502 to use for the communication. The configuration may prioritize a radio of a set of radios for communication, for example prioritizing the HPR of the UE 502 with a higher priority, and prioritizing the LPR of the UE 502 with a lower priority, such that the UE 502 may use the LPR for the communication if the HPR is in a busy or inactive state during the scheduled communication. The configuration may include at least one of (a) a minimum time threshold for the UE to switch between operating the first radio at the UE in the second mode and operating the second radio at the UE in the first mode, (b) a PDCCH occasion indicator associated with each of the radios (e.g., a first PDCCH occasion indicator associated with the HPR of the UE 502 and a second PDCCH occasion indicator association with the LPR of the UE 502), (c) a slot format associated with each of the radios (e.g., a first slot format associated with the HPR of the UE 502 and a second slot format associated with the LPR of the UE 502), or (d) a signal type associated with each of the radios (e.g., a first signal type associated with the HPR of the UE 502 and a second signal type associated with the LPR of the UE 502). The signal type may include at least one of a PDCCH monitoring occasions (PMO), a semi-persistent scheduling (SPS) occasion, a configured grant (CG) occasion, a sounding reference signal (SRS) occasion, or a CSI-RS occasion. The configuration may be based on the UE capability 506. For example, if the UE 502 indicates via the UE capability 506 that it is capable of simultaneously communicating with both the HPR and the LPR of the UE 502, the network node 504 may configure the UE 502 to communicate with both the HPR and the LPR simultaneously, offloading some of the communication transmissions from the HPR to the LPR. If the UE 502 indicates via the UE capability 506 that it is not capable of simultaneously communicating with both the HPR and the LPR of the UE 502, the network node 504 may configure the UE 502 to communicate with the HPR during a first period of time, and the LPR for a second period of time, and switch the HPR to a sleep mode during the second period of time.

In one aspect, if the UE capability 506 indicates that the UE 502 supports a RedCap function and does not support a smart phone function, the network node 504 may use relaxed standards for UE complexity and/or may use a relaxed processing timeline. In some aspects, the network node 504 may use a smaller bandwidth for a UE that supports a RedCap function and does not support a smart phone function than a UE that supports a smart phone function, may use one carrier for a UE that supports a RedCap function and does not support a smart phone function than a UE that supports a smart phone function, may use a smaller number of Tx and/or Rx antennas for a UE that supports a RedCap function and does not support a smart phone function than a UE that supports a smart phone function, or may use a smaller number of MIMO layers for a UE that supports a RedCap function and does not support a smart phone function than a UE that supports a smart phone function. In some aspects, the network node 504 may use a relaxed processing timeline for data scheduling, processing, HARQ-ACK feedback, or CSI processing for a UE that supports a RedCap function and does not support a smart phone function than a processing timeline for a UE that supports a smart phone function.

The network node 504 may transmit a signal with a configuration for the HPR and/or the LPR of the UE 502. The signal may be transmitted to the LPR or to the HPR. In one aspect, the network node 504 may transmit an LP signal 510 with a configuration for the HPR and/or the LPR of the UE 502 to the LPR of the UE 502. The UE 502 may receive the LP signal 510 with a configuration for the HPR and/or the LPR of the UE 502 from the network node 504 via the LPR of the UE 502. At 512, the UE 502 may configure the HPR and/or the LPR of the UE 502 using the LP signal 510. The LP signal 510 may include a configuration for the HPR. In other words, the UE 502 may receive the LP signal 510 via its LPR, and may use the LP signal 510 to configure its HPR. The UE 502 may configure its HPR using the configuration of the LP signal 510. The UE 502 may communicate the one or more transmissions 514 with the network node 504 via its HPR based on the configuration of the LP signal 510. The LP signal 510 may include a configuration for the LPR. The UE 502 may configure its LPR using the configuration of the LP signal 510. The UE 502 may communicate the one or more transmissions 516 with the network node 504 via its LPR based on the configuration of the LP signal 510.

In one aspect, the UE 502 may be configured to support simultaneous connectivity with the network node 504 in Uu with both its HPR and its LPR. In some aspects, the UE 502 may operate both its HPR and its LPR at the same time. In other words, the UE 502 may communicate (transmit or receive) the one or more transmissions 514 with the network node 504 via its HPR and may communicate (transmit or receive) the one or more transmissions 516 with the network node 504 via its LPR at the same time. For example, the UE 502 may communicate the one or more transmissions 514 with the network node 504 via its HPR using a first set of frequencies and may communicate the one or more transmissions 516 with the network node 504 via its LPR using a second set of frequencies, where the first set of frequencies are not overlapping or adjacent with the second set of frequencies (i.e., the first set of frequencies do not interfere with the second set of frequencies). In some aspects, the UE 502 may operate both its HPR and its LPR in separated times using time domain multiplexing (TDM). In other words, the UE 502 may communicate the one or more transmissions 514 with the network node 504 via its HPR during a first set of time periods and may communicate the one or more transmissions 516 with the network node 504 via its LPR during a second set of time periods, where the first set of time periods do not overlap with the second set of time periods. At least one of first set of time periods may be interleaved between two of the second set of time periods, or at least one of the second set of time periods may be interleaved between two of the first set of time periods, such that a large time period may include both the first set of time periods and the second set of time periods.

The LP signal 510 with a configuration for the HPR and/or the LPR of the UE 502 transmitted to the LPR of the UE 502 may have an indicator of whether to use the HPR and/or the LPR of the UE 502 for connected mode during a time period. The LP signal 510 may be an LP-WUS that includes an indicator to both wake-up the HPR and to either switch the LPR to sleep mode, keep the LPR in a periodic active mode, or switch the LPR to an active mode. The LP-WUS may have an indicator for each of the HPR and the LPR. The indictor may indicate for the UE 502 to wake up transmission components of the radio and not to wake up reception components of the radio, to wake up reception components of the radio and not to wake up transmission components of the radio, or to wake up both transmission and reception components of the radio.

In some aspects, the LP signal 510 may indicate an operation at the HPR of the UE 502. In some aspects, the LP signal 510 may indicate one or more cast types (e.g., unicast, broadcast, or multi-cast) of the data to transmit or receive as the one or more transmissions 514. In response to the LP signal 510 indicating the one or more cast types, the UE 502 may be configured to receive scheduling PDCCH for the cast type. In response to the LP signal 510 indicating the one or more cast types, the UE 502 may be configured to determine the QCL source and transmission configuration indicator (TCI) state for data communication associated with the cast type. In response to the LP signal 510 indicating the one or more cast types, the UE 502 may be configured to receive CSI-RS associated with the cast type. In response to the LP signal 510 indicating the one or more cast types, the UE 502 may be configured to use associated configured resources for transmission (e.g., a CG) or reception (e.g., SPS) associated with the cast type. The LP signal 510 may indicate one or more communication modes (e.g., a transmission mode, a reception mode, or a transmission and reception mode) associated with the data to transmit or receive as the one or more transmissions 514. The UE 502 may switch to the communication mode when communicating with the network node 504 or another wireless device. The transmission mode may be referred to as an UL only mode. The reception mode may be referred to as a DL only mode. The UE 502 may be configured to switch one or more components to a sleep mode based on the communication mode. For example, in response to the UE 502 switching to a transmission mode, the UE 502 may deactivate or otherwise switch to sleep mode at least one of a software (SW) module/component, a firmware (FW) module/component, a hardware (HW) module/component, or a radio frequency (RF) module/component associated with downlink or reception mode. As used herein, a component may be a portion of a UE that consumes power when active, such as an antenna or a decoder. In response to the UE 502 switching to a reception mode, the UE 502 may deactivate or otherwise switch to sleep mode at least one of an SW component, an FW component, an HW component, or an RF component associated with uplink or transmission mode. In some aspects, the LP signal 510 may indicate a duplex mode (e.g., half duplex mode, full duplex mode) associated with a communication of the one or more transmissions 514. In response to the LP signal 510 indicating the duplex mode, the UE 502 may determine the QCL source and TCI state for data communication associated with the duplex mode. For example, the UE 502 may use a different optimal beam for full duplex mode as self-interference may be present in full duplex mode but may not be present in half duplex mode. In response to the LP signal 510 indicating the duplex mode, the UE 502 may determine a slot format for the indicated duplexing mode. In some aspects, the LP signal 510 may indicate service information (e.g., enhanced mobile broadband (eMBB) service information, ultra reliable low latency communications (URLLC) service information, extended reality (XR) service information) associated with a communication of the one or more transmissions 514. In response to the LP signal 510 indicating the service information, the UE 502 may select a requirement associated with the service information to use to determine a wakeup time. The requirement may be, for example, a latency requirement, a bandwidth requirement, or a number of CCs requirement. The requirement may be based on a quality-of-service (QoS) associated with the service information. In some aspects, the LP signal 510 may indicate a device type function associated with the one or more transmissions 514. In response to the LP signal 510 indicating the device type function, the UE 502 may select a set of requirements associated with the device type function (e.g., RedCap function, smart phone function) to communicate the one or more transmissions 514. For example, the UE 502 may use relaxed standards for UE complexity and/or may use a relaxed processing timeline for a RedCap device type function. In some aspects, the UE 502 may use a smaller bandwidth for a RedCap function transmission, may use one carrier for a RedCap function transmission, may use a smaller number of Tx and/or Rx antennas for a RedCap function transmission, or may use a smaller number of MIMO layers for a RedCap function transmission. In some aspects, the UE 502 may use a relaxed processing timeline for data scheduling, processing, HARQ-ACK feedback, or CSI processing for a RedCap function transmission. In some aspects, the LP signal 510 may indicate a communication type associated with communicating a signal at an LPR of the UE, such as a Uu communication or a sidelink communication, a cross-link interference (CLI) measurement associated with communicating a signal at an LPR of the UE, or a non-data service parameter (e.g., sensing or positioning) associated with communicating a signal at an LPR of the UE. In some aspects, the LP signal 510 may indicate a connection type (e.g., Uu communication, sidelink communication, CLI measurement, non-data service communication) associated with the one or more transmissions 514. The non-data service communication may include, for example, sensing or positioning. In response, the UE 502 may determine the QCL source, TCI state, tracking loop state, automatic gain control (AGC), or a reference signal associated with the connection type.

If the UE 502 is not configured to support operation of both its HPR and its LPR simultaneously (but may support operation of both its HPR and its LPR in active modes), the network node 504 may, at 508, schedule operation of the HPR and the LPR of the UE 502 using a transition time between operation of the HPR of the UE 502 and the LPR of the UE 502, ensuring that the schedule includes the transition time between an operation of the PR of the UE 502 and the operation of the LPR of the UE 502. In some aspects, the LP signal 510 may have an indicator for the UE 502 to configure a radio to relay a signal from a wireless device, for example the network node 504 or another wireless device 505. For example, the wireless device 505 may transmit one or more transmissions 513 to the HPR of the UE 502, and the UE 502 may relay the one or more transmissions 513 as the one or more transmissions 514 via its HPR or as the one or more transmissions 516 via its LPR. In another example, the wireless device 505 may transmit one or more transmissions 515 to the LPR of the UE 502, and the UE 502 may relay the one or more transmissions 515 as the one or more transmissions 514 via its HPR or as the one or more transmissions 516 via its LPR. In some aspects, the LP signal 510 have an indicator for the UE 502 to configure a radio to help in another service than its own data service, for example to read an RFID tag or to source an RFID tag. For example, the wireless device 505 may be a passive IoT device, a backscatter-based radio, or an RFID tag radio. A passive IoT device may be a device that does not have a power source of its own, and harvests power from RF signals transmitted to the passive IoT device, such as continuous wave (CW) signals. A wireless device, such as the network node 504 or the UE 502 may be configured to periodically transmit a CW signal to a passive IoT device to recharge its power, or may be configured to transmit a CW signal to the passive IoT device for a period of time before transmitting a communication signal to ensure that the passive IoT device has enough power to function. A backscatter-based radio may be an RF device configured to transmit signals by reflecting, or backscattering, signals transmitted to the backscatter-based radio. The backscatter-based radio may superimpose, or add, its own signal to the backscattered signal to transmit a separate signal. An RFID tag radio may be a device that responds to RF signals transmitted to the RFID tag radio. The RFID tag radio may be a passive IoT device, a backscatter-based radio, or any other wireless device that transmits and receives RF signals with wireless devices, such as the UE 502 or the network node 504.

The wireless device 505 may transmit the one or more transmissions 513 to the HPR of the UE 502, and the UE 502 may read the one or more transmissions 513 via its HPR. In another example, the wireless device 505 may transmit the one or more transmissions 515 to the LPR of the UE 502, and the UE 502 may read the one or more transmissions 515 via its LPR. In another example, the UE 502 may transmit the one or more transmissions 513 to the wireless device 505 via its HPR to source or power the wireless device 505. In another example, the UE 502 may transmit the one or more transmissions 515 to the wireless device 505 via its LPR to source or power the wireless device 505.

In one aspect, the LP signal 510 may include an indicator of an operation that enables a flexible dynamic selection of an operation when the network node 504 configures overlapping operations in time (e.g., a first transmission to a first device and a second transmission to the HPR of the UE 502 during the same period of time) or with a time gap below a threshold (e.g., a first transmission to a first device followed by a second transmission to the HPR of the UE 502, with a time gap below a safety threshold of time). The threshold may correspond with the minimum time for the UE 502 to switch between the operations. The LP signal may indicate an operation for the UE 502 at its LPR, for example a cast type and a duplex mode, and the UE 502 may conduct the communication at its HPR.

In one aspect, a network may be configured to schedule one or more PMOs for unicast data and multi-cast data in an overlapping time duration or with a time gap below a threshold. The network node 504 may transmit an LP signal 510 to the LPR of the UE 502, which may indicate which type of PDCCH the UE 502 monitors with its HPR as the one or more transmissions 514. In another aspect, a network may be configured to schedule a communication with a first slot format for full duplex and schedule a communication with a second slot format for half duplex in an overlapping time duration or with a time gap below a threshold. The network node 504 may transmit an LP signal 510 to the LPR of the UE 502, which may indicate which slot format the UE 502 follows for its communication of the one or more transmissions 514 at its HPR. In another aspect, a network may configure a Uu communication signal (e.g., PMO, SPS occasion, CG occasion, SRS, CSI-RS), CLI measurement resource, and/or a sensing signal in an overlapping time duration or with a time gap below a threshold. The network node 504 may transmit the LP signal 510 to the LPR of the UE 502, which may indicate to the UE 502 which signal to process at its LPR as the one or more transmissions 514.

In some aspects, the network node 504 may transmit one of multiple candidate LP signals during a configured occasion to transmit the LP signal 510. For example, the network node 504 may transmit a first LP-WUS as the LP signal 510 to indicate to the UE 502 to wake up its HPR as a smart phone, or a second LP-WUS as the LP signal 510 to indicate to the UE 502 to wake up its HPR as a RedCap device. In other aspects, the network node 504 may transmit a combination of multiple candidate LP signals during a configured occasion that may accept a plurality of LP signals as the LP signal 510. For example, the configured occasion may accept two LP signals, one LP signal in a first slot (or first set of RBs) and one LP signal in a second slot (or second set of RBs). The network node 504 may transmit at one of two candidate signals for each slot, or set of RBs, allowing the network node 504 to transmit at most four combinations of LP signals as the LP signal 510.

In some aspects, the network node 504 may transmit a set of LP signals to have some common configuration parameters and some individual parameters, which may save bandwidth during transmission to the LPR of the UE 502. For example, the set of LP signals may share at least one of a number of slots, a QCL source, a time domain symbol pattern (including the starting symbol in the first slot), a WUS set ID, a frequency domain RB pattern (e.g., number of RBs, a starting RB), a frequency domain RE pattern (e.g., RE interval, a starting RE in an RB), or a transmit power. The set of LP signals may not share at least one of a starting RE offset in a set of RBs, a starting symbol in the first slot, a WUS generation ID (e.g., scrambling ID), a repetition, a periodicity between occasions, or a time between occasions. The repetition may be a number of times when a bit of a sequence may be repeated or may be a number of times when a sequence may be repeated. A periodicity between occasions or a time between occasions may refer to occasions when the UE 502 monitors for a signal, such as a PRS or an SSB. Each of a plurality of LP signals may have a different indication. For example, a first LP signal may indicate a cast type for an operation at the UE 502, and a second LP signal may indicate the device type for an operation at the UE 502.

The LP signal 510 with a configuration for the HPR and/or the LPR of the UE 502 transmitted to the LPR of the UE 502 may have an indicator of whether to switch any of the components of the HPR and/or the LPR of the UE 502 to a sleep mode for a time period. The LP signal 510 may be an LP go-to-sleep (LP-GTP) signal having an indicator for the UE 502 to switch transmission components of its HPR to a sleep mode, to switch reception components of its HPR to a sleep mode, to switch both transmission and reception components of its HPR to a sleep mode, to switch transmission components of its LPR to a sleep mode, to switch reception components of its LPR to a sleep mode, and/or to switch both transmission and reception components of its LPR to a sleep mode.

The UE 502 may be configured to limit communication using its LPR to a subset of functions that its HPR may perform when the UE 502 is configured to operate both its LPR and its HPR in active mode simultaneously. For example, the UE 502 may be configured to limit communication with the network node 504 via the one or more transmissions 516 to transmit a SR as the one or more transmissions 516 via the LPR of the UE 502, to transmit HARQ-ACK feedback as the one or more transmissions 516 via the LPR of the UE 502 for data received via the one or more transmissions 514 to the HPR of the UE 502, to transmit HARQ-ACK feedback as the one or more transmissions 516 via the LPR of the UE 502 for data received via the one or more transmissions 516 to the LPR of the UE 502, to transmit CSI feedback as the one or more transmissions 516 via the LPR of the UE 502 for an RS (e.g., a CSI-RS) received via the one or more transmissions 514 to the HPR of the UE 502, to transmit CSI feedback as the one or more transmissions 516 via the LPR of the UE 502 for an LP-RS (e.g., a LP CSI-RS) received via the one or more transmissions 516 to the LPR of the UE 502, and/or to receive a scheduling grant (UL/DL) as the one or more transmissions 516 via the LPR of the UE 502 for the one or more transmissions 514 via the HPR of the UE 502.

In some aspects, the UE 502 may be configured to apply one or more collision rules for a collision at the HPR of the UE 502 prior to applying one or more collision rules for a collision at the LPR of the UE 502. In other words, for collision handling, the UE 502 may be configured to handle a collision with the one or more transmissions 514 at the HPR of the UE 502 first as a higher priority, and then to handle a collision with the one or more transmissions 516 at the LPR of the UE 502. Some collision handling rules may indicate for the UE 502 to drop a colliding transmission. Instead of dropping a colliding transmission with the one or more transmissions 514 at the HPR of the UE 502, the UE 502 may be configured to transmit the colliding transmission via the LPR as the one or more transmissions 516 to the network node 504.

In some aspects, the UE 502 may be configured to multiplex one or more transmissions with another transmission when the UE 502 is configured to operate its LPR and its HPR in active mode simultaneously. For example, the UE 502 may multiplex a first HARQ-ACK feedback associated with the one or more transmissions 514 received from the network node 504 via its HPR with a second HARQ-ACK feedback associated with the one or more transmissions 516 received from the network node 504 via its LPR, may multiplex a first HARQ-ACK feedback associated with the one or more transmissions 514 received from the network node 504 via its HPR with a first CSI feedback associated with the one or more transmissions 516 received from the network node 504 via its LPR, may multiplex a first CSI feedback associated with the one or more transmissions 514 received from the network node 504 via its HPR with a first HARQ-ACK feedback associated with the one or more transmissions 516 received from the network node 504 via its LPR, or may multiplex a first CSI feedback associated with the one or more transmissions 514 received from the network node 504 via its HPR with a second CSI feedback associated with the one or more transmissions 516 received from the network node 504 via its LPR. The UE 502 may be configured to multiplex the signals before encoding or after encoding. In other words, the UE 502 may assign a different number of resources, resource elements (REs), and/or resource blocks (RBs) to the signals before or after multiplexing the signals. The UE 502 may be configured to transmit the multiplexed signal via its HPR as the one or more transmissions 514. The UE 502 may be configured to transmit the multiplexed signal via its LPR as the one or more transmissions 516. The HPR and the LPR of the UE 502 may have distinct timelines or schedules. For example, DCI to the UE 502 received as the one or more transmissions 514 may indicate a timeline or schedule for the HPR of the UE 502 or for the HPR and the LPR of the UE 502. A LP-RS to the UE 502 received as the LP signal 510 or the one or more transmissions 516 may indicate a timeline or schedule for the LPR of the UE 502 or for the HPR and the LPR of the UE 502. The network node 504 may schedule a timeline or schedule for the multiplexed signal based on a priority of signals, or a radio priority, to optimize receipt of feedback from the UE 502 (e.g., receive the feedback in less time, or receive the feedback using less power from the UE 502).

In some aspects, the UE 502 may be configured to transmit a signal including multiplexed CSI feedback or CSI reports using PUCCH resources as the one or more transmissions 514 via the HPR of the UE 502 or as the one or more transmissions 516 via the LPR of the UE 502. The UE 502 may multiplex the CSI feedback or CSI reports before or after encoding. If the UE 502 multiplexes the CSI feedback or the CSI reports after encoding, the UE 502 may be configured to assign different allocations to each report, such that each report may have a same or distinct priority level. In some aspects, a timeline for a CSI report transmitted using the LPR of the UE 502 may be different than a timeline for a CSI report transmitted using the HPR of the UE 502. In some aspects, the timeline for the CSI report transmitted using the LPR of the UE 502 may be more relaxed than a timeline for the CSI report transmitted using the HPR of the UE 502.

In one aspect, the network node 504 may transmit a HP signal 520 with a configuration for the HPR and/or the LPR of the UE 502 to the HPR of the UE 502. The UE 502 may receive the HP signal 520 with a configuration for the HPR and/or the LPR of the UE 502 from the network node 504 via the HPR of the UE 502. At 522, the UE 502 may configure the HPR and/or the LPR of the UE 502 using the HP signal 520. The HP signal 520 may include a configuration for the LPR. In other words, the UE 502 may receive the HP signal 520 via its HPR, and may use the HP signal 520 to configure its LPR. The UE 502 may configure its LPR using the configuration of the HP signal 520. The UE 502 may communicate the one or more transmissions 524 with the network node 504 via its HPR based on the configuration of the HP signal 520. The HP signal 520 may include a configuration for the LPR. The UE 502 may configure its LPR using the configuration of the HP signal 520. The UE 502 may communicate the one or more transmissions 526 with the network node 504 via its LPR based on the configuration of the HP signal 520.

In one aspect, the UE 502 may be configured to support simultaneous connectivity with the network node 504 in Uu with both its HPR and its LPR. In some aspects, the UE 502 may operate both its HPR and its LPR at the same time. In other words, the UE 502 may communicate (transmit or receive) the one or more transmissions 524 with the network node 504 via its HPR and may communicate (transmit or receive) the one or more transmissions 526 with the network node 504 via its LPR at the same time. For example, the UE 502 may communicate the one or more transmissions 524 with the network node 504 via its HPR using a first set of frequencies and may communicate the one or more transmissions 526 with the network node 504 via its LPR using a second set of frequencies, where the first set of frequencies are not overlapping or adjacent with the second set of frequencies (i.e., the first set of frequencies do not interfere with the second set of frequencies). In some aspects, the UE 502 may operate both its HPR and its LPR in separated times using time domain multiplexing (TDM). In other words, the UE 502 may communicate the one or more transmissions 524 with the network node 504 via its HPR during a first set of time periods and may communicate the one or more transmissions 526 with the network node 504 via its LPR during a second set of time periods, where the first set of time periods do not overlap with the second set of time periods. At least one of first set of time periods may be interleaved between two of the second set of time periods, or at least one of the second set of time periods may be interleaved between two of the first set of time periods, such that a large time period may include both the first set of time periods and the second set of time periods.

The HP signal 520 with a configuration for the HPR and/or the LPR of the UE 502 transmitted to the HPR of the UE 502 may have an indicator of whether to use the HPR and/or the LPR of the UE 502 for connected mode during a time period. The HP signal 520 may indicate whether to use the LPR for connected mode while the HPR is in connected mode. The HP signal 520 may include an indicator to either switch the LPR to sleep mode, keep the LPR in a periodic active mode, or switch the LPR to an active mode. The HP signal 520 may have an indicator for each of the HPR and the LPR. The indictor may indicate for the UE 502 to wake up transmission components of the radio and not to wake up reception components of the radio, to wake up reception components of the radio and not to wake up transmission components of the radio, or to wake up both transmission and reception components of the radio. If the UE 502 is not configured to support operation of both its HPR and its LPR simultaneously, the network node 504 may, at 508, schedule operation of the HPR and the LPR of the UE 502 using a transition time between operation of the HPR of the UE 502 and the LPR of the UE 502, ensuring that the schedule includes the transition time between an operation of the PR of the UE 502 and the operation of the LPR of the UE 502. In some aspects, the HP signal 520 may have an indicator for the UE 502 to configure a radio to relay a signal from a wireless device, for example the network node 504 or another wireless device 505. For example, the wireless device 505 may transmit one or more transmissions 523 to the HPR of the UE 502, and the UE 502 may relay the one or more transmissions 523 as the one or more transmissions 524 via its HPR or as the one or more transmissions 526 via its LPR. In another example, the wireless device 505 may transmit one or more transmissions 525 to the LPR of the UE 502, and the UE 502 may relay the one or more transmissions 525 as the one or more transmissions 524 via its HPR or as the one or more transmissions 526 via its LPR. In some aspects, the HP signal 520 have an indicator for the UE 502 to configure a radio to help in another service than its own data service, for example to read an RFID tag or to source an RFID tag. For example, the wireless device 505 may be a passive IoT device, a backscatter-based radio, or an RFID tag radio. The wireless device 505 may transmit the one or more transmissions 523 to the HPR of the UE 502, and the UE 502 may read the one or more transmissions 523 via its HPR. In another example, the wireless device 505 may transmit the one or more transmissions 525 to the LPR of the UE 502, and the UE 502 may read the one or more transmissions 525 via its LPR. In another example, the UE 502 may transmit the one or more transmissions 523 to the wireless device 505 via its HPR to source or power the wireless device 505. In another example, the UE 502 may transmit the one or more transmissions 525 to the wireless device 505 via its LPR to source or power the wireless device 505.

The HP signal 520 with a configuration for the HPR and/or the LPR of the UE 502 transmitted to the HPR of the UE 502 may have an indicator of whether to switch any of the components of the HPR and/or the LPR of the UE 502 to a sleep mode for a time period. The HP signal 520 may include an indicator for the UE 502 to switch transmission components of its HPR to a sleep mode, to switch reception components of its HPR to a sleep mode, to switch both transmission and reception components of its HPR to a sleep mode, to switch transmission components of its LPR to a sleep mode, to switch reception components of its LPR to a sleep mode, and/or to switch both transmission and reception components of its LPR to a sleep mode.

The UE 502 may be configured to limit communication using its LPR to a subset of functions that its HPR may perform when the UE 502 is configured to operate both its LPR and its HPR in active mode simultaneously. For example, the UE 502 may be configured to limit communication with the network node 504 via the one or more transmissions 526 to transmit a SR as the one or more transmissions 526 via the LPR of the UE 502, to transmit HARQ-ACK feedback as the one or more transmissions 526 via the LPR of the UE 502 for data received via the one or more transmissions 524 to the HPR of the UE 502, to transmit HARQ-ACK feedback as the one or more transmissions 526 via the LPR of the UE 502 for data received via the one or more transmissions 526 to the LPR of the UE 502, to transmit CSI feedback as the one or more transmissions 526 via the LPR of the UE 502 for an RS (e.g., a CSI-RS) received via the one or more transmissions 524 to the HPR of the UE 502, to transmit CSI feedback as the one or more transmissions 526 via the LPR of the UE 502 for an LP-RS (e.g., a LP CSI-RS) received via the one or more transmissions 526 to the LPR of the UE 502, and/or to receive a scheduling grant (UL/DL) as the one or more transmissions 526 via the LPR of the UE 502 for the one or more transmissions 524 via the HPR of the UE 502.

In some aspects, the UE 502 may be configured to apply one or more collision rules for a collision at the HPR of the UE 502 prior to applying one or more collision rules for a collision at the LPR of the UE 502. In other words, for collision handling, the UE 502 may be configured to handle a collision with the one or more transmissions 524 at the HPR of the UE 502 first as a higher priority, and then to handle a collision with the one or more transmissions 526 at the LPR of the UE 502. Some collision handling rules may indicate for the UE 502 to drop a colliding transmission. Instead of dropping a colliding transmission with the one or more transmissions 524 at the HPR of the UE 502, the UE 502 may be configured to transmit the colliding transmission via the LPR as the one or more transmissions 526 to the network node 504.

In some aspects, the UE 502 may be configured to multiplex one or more transmissions with another transmission when the UE 502 is configured to operate its LPR and its HPR in active mode simultaneously. For example, the UE 502 may multiplex a first HARQ-ACK feedback associated with the one or more transmissions 524 received from the network node 504 via its HPR with a second HARQ-ACK feedback associated with the one or more transmissions 526 received from the network node 504 via its LPR, may multiplex a first HARQ-ACK feedback associated with the one or more transmissions 524 received from the network node 504 via its HPR with a first CSI feedback associated with the one or more transmissions 526 received from the network node 504 via its LPR, may multiplex a first CSI feedback associated with the one or more transmissions 524 received from the network node 504 via its HPR with a first HARQ-ACK feedback associated with the one or more transmissions 526 received from the network node 504 via its LPR, or may multiplex a first CSI feedback associated with the one or more transmissions 524 received from the network node 504 via its HPR with a second CSI feedback associated with the one or more transmissions 526 received from the network node 504 via its LPR. The UE 502 may be configured to multiplex the signals before encoding or after encoding. In other words, the UE 502 may assign a different number of resources, resource elements (REs), and/or resource blocks (RBs) to the signals before or after multiplexing the signals. The UE 502 may be configured to transmit the multiplexed signal via its HPR as the one or more transmissions 524. The UE 502 may be configured to transmit the multiplexed signal via its LPR as the one or more transmissions 526. The HPR and the LPR of the UE 502 may have distinct timelines or schedules. For example, DCI to the UE 502 received as the HP signal 520 or the one or more transmissions 524 may indicate a timeline or schedule for the HPR of the UE 502 or for the HPR and the LPR of the UE 502. A LP-RS to the UE 502 received as the one or more transmissions 526 may indicate a timeline or schedule for the LPR of the UE 502 or for the HPR and the LPR of the UE 502. The network node 504 may schedule a timeline or schedule for the multiplexed signal based on a priority of signals, or a radio priority, to optimize receipt of feedback from the UE 502 (e.g., receive the feedback in less time, or receive the feedback using less power from the UE 502).

In some aspects, the UE 502 may be configured to transmit a signal including multiplexed CSI feedback or CSI reports using PUCCH resources as the one or more transmissions 524 via the HPR of the UE 502 or as the one or more transmissions 526 via the LPR of the UE 502. The UE 502 may multiplex the CSI feedback or CSI reports before or after encoding. If the UE 502 multiplexes the CSI feedback or the CSI reports after encoding, the UE 502 may be configured to assign different allocations to each report, such that each report may have a same or distinct priority level. In some aspects, a timeline for a CSI report transmitted using the LPR of the UE 502 may be different than a timeline for a CSI report transmitted using the HPR of the UE 502. In some aspects, the timeline for the CSI report transmitted using the LPR of the UE 502 may be more relaxed than a timeline for the CSI report transmitted using the HPR of the UE 502.

The UE 502 may have one or more clocks, associated with its HPR and/or associated with its LPR, such as the set of clocks 407 associated with the radio 406 and the set of clocks 409 associated with the radio 408 in FIGS. 4A and 4B. The UE 502 may indicate one or more parameters associated with one or more of its clocks to the network node 504. The one or more parameters may include, for example, a clock type (e.g., an RTC or an LO XO), a frequency drift, a frequency drift range, a maximum frequency error, a maximum frequency error range, a clock schedule, or a UE mode (e.g., RRC mode, power saving mode) associated with one or more of the clocks of the UE 502. In some aspects, the frequency drift range may be indicated as a range of values that may span a minimum and a maximum value that the frequency of the clock may drift (e.g., clock is expected to be between X and Y). In other aspects, the frequency drift range may be indicated as a table index to a possible value of drift that indicates the uncertainty of the clock. In other words, the frequency drift range may indicate the minimum and maximum uncertainty values of the clock. The frequency drift may be expressed in terms of ppm/s. The frequency drift range may be expressed as a minimum and maximum value for frequency drift in terms of ±x ppm/s. The maximum frequency error may be expressed in terms of ppm. The maximum frequency error range may be expressed as a minimum and maximum value for frequency error in terms of ±x ppm. The one or more parameters may be expressed as a value, a range of values, a set of values, a mean parameter statistic (i.e., a mean value of the parameter value over a time period), or a variance parameter statistic (i.e., a variance of the parameter value over a time period). The UE mode may include, for example, an RRC connected mode, an RRC inactive mode, an RRC idle mode, a full power mode, a low power mode, a sleep mode, or traffic statistics and its priority/QoS which may be associated with a use of a clock with an associated radio. The UE 502 may also or alternatively report statistics (e.g., the average and variance) of each quantity (frequency drift and maximum frequency error), allowing the network node 504 to calculate expected values over time.

The UE 502 may indicate the one or more parameters to the network node 504 via the one or more transmissions 514 or 524 via the HPR of the UE 502, or via the one or more transmissions 516 or 526 via the LPR of the UE 502. In one aspect, the UE 502 may indicate the one or more parameters via its HPR using level 1 (L1), level 2 (L2), or a level 3 (L3) indication, a user-assistance information (UAI), an initial access message, or a capability information message. The one or more parameters may indicate an identifier of the clock, or clocks, which the parameters are associated with. The identifier may be a unique identifier of the clock, a unique identifier of the radio that the clock is associated with, a type of the clock, or a type of radio that the clock is associated with (e.g., HPR, LPR, MR, LP-WUR).

In some aspects, the one or more transmissions 514 or the one or more transmissions 524 from the network node 504 to the HPR of the UE 502 may include a configuration for correcting a time or frequency error/drift of one or more clocks of the UE 502. The configuration may be transmitted as DCI, a MAC-CE, or an RRC configuration to the HPR of the UE 502. In some aspects, the one or more transmissions 516 or the one or more transmissions 526 from the network node to the LPR of the UE 502 may include a configuration for correcting a time or frequency error/drift of one or more clocks of the UE 502. The UE 502 may transmit information about its one or more clocks to the network node 504 as the UE capability 506. The information may include the one or more parameters of the one or more clocks of the UE 502. The UE 502 may transmit information about its one or more clocks to the network node 504 as the one or more transmissions 514 from its HPR or the one or more transmissions 524 526 from its HPR.

In response, the network node 504 may adjust a periodicity of a synchronization signal to the UE 502 to correct the clock. The synchronization signal may be, for example, an LP synchronization signal (LP-SS), an LP reference signal (LP-RS), an LP wake-up signal (LP-WUS), or an LP-sync preamble signal. The LP-SS may be a type of LP-RS transmitted to the LPR of the UE 502, for example as the one or more transmissions 516 or the one or more transmissions 526. The UE 502 or the network node 504 may indicate a periodicity, repetition, number of time resources, or number of frequency resources of the LP-SS, LP-WUS, LP-sync preamble signal, or LP-RS based on the one or more parameters. For example, the worse the clock (a frequency drift having a ±x ppm/s greater than or equal to a threshold level), the lower the periodicity of the LP-WUS, LP-RS, LP-sync preamble signal, or LP-SS. In some aspects, the one or more transmissions 516 or the one or more transmissions 526 from the network node 504 to the LPR of the UE 502 may include an LP-RS, an LP-SS, LP-sync preamble signal, or an LP-WUS that the UE 502 may use for time tracking, time synchronization, frequency tracking, frequency synchronization, time error estimation and correction, or frequency error estimation and correction of a clock of the UE 502. The LP-RS, LP-SS, LP-sync preamble signal, or LP-WUS may also be used for channel estimation at the LPR.

The network node 504 may indicate to the UE 502 which a set of clocks to use with a radio based on a clock configuration (e.g., via the LP signal to the LPR of the UE 502 or the HP signal 520 to the LPR of the UE 502) or based on the synchronization signal, such as an LP-SS (e.g., via the one or more transmissions 516 or the one or more transmissions 526 to the LPR of the UE 502), or a synchronization signal to the HPR of the UE 502 (e.g., via the one or more transmissions 514 or the one or more transmissions 524 to the HPR of the UE 502). The indication may specify which configuration to use based on a time period, a UE mode (e.g., RRC state or power mode), or traffic statistics/parameters associated with the UE 502 (e.g., expected traffic priority/QoS). The indication may specify which configuration to use based on a priority and/or a QoS of predicted data traffic (e.g., UL or DL). The predicted data traffic may include expected data traffic scheduled by the network node 504 or another network entity. In one aspect, the network node 504 may indicate to the UE 502 to use a first clock for predicted data having a priority greater than or equal to a threshold level and/or a QoS greater than or equal to a threshold level, and use a second clock for predicted data having a priority less than or equal to a threshold level and/or a QoS less than or equal to a threshold level. For example, if the UE 502 is in RRC connected mode and is in a full-power mode, and the predicted data during a time period is of high priority (e.g., L1 and/or L2) and a high QoS (for at least UL or DL traffic), the UE 502 may use a high accuracy clock due to the importance of the data. In some aspects, the network node 504 may use the corresponding configuration of a corresponding clock and the UE 502 may monitor the configured signals with the corresponding configuration, based on the indication from the network node 504 to the UE 502 to use that clock (or arrival of important data for transmission/UL) OR based on a reported predicted data traffic priority/QoS to the network node 504 by prediction. In some aspects, the network node 504 may use one or more prediction techniques to determine when data of such priority is predicted to be transmitted by, or received by, a radio of the UE 502. In some aspects, the UE 502 may indicate to the network node 504 that data of such priority is predicted to be transmitted by, or received by, a radio of the UE 502. In some cases, the network node 504 may indicate to the UE 502 the DL traffic for each priority/QoS and prediction to the UE 502. In response, the UE 502 may use a clock associated with the prediction. In some aspects, the UE 502 may be configured to indicate one or more parameters having a traffic statistic of one or more logical group channel or traffic to the network node 504. In response, the network node 504 may determine a configuration of a clock to use with a radio at the UE 502. In other aspects, the network node 504 may indicate a clock to use with a radio during an RRC connected mode or during an RRC state. In some aspects, the network node 504 may indicate which configuration for a radio is associated with each clock of the UE 502. In some aspects, a clock may have an ID and the configuration of signals may be associated with the ID of the clock.

In response to receiving the LP signal 510 or the HP signal 520 including a clock configuration, the UE 502 may be configured to configure or synchronize at least one clock associated with the clock configuration. The HP signal 520 including the clock configuration may be DCI, a MAC-CE, or an RRC configuration. In some aspects, the UE 502 may (a) track a configuration time associated with the clock configuration, (b) track a configuration frequency associated with the clock configuration, (c) synchronize a time associated with the clock based on a configuration time associated with the first clock configuration, (d) synchronize a frequency associated with the clock based on a configuration frequency associated with the clock configuration, (e) correct a time associated with the clock based on a time estimation error calculated based on the clock configuration, (f) correct a frequency associated with the clock based on a frequency estimation error calculated based on the clock configuration, or (g) estimate a channel at the first radio based on the clock configuration. The network node 504 may configure the clock configuration based on one or more parameters received from the UE 502, for example one or more parameters of the UE capability 506. In some aspects, the UE 502 may transmit an update of the one or more parameters to the network node 504 as the one or more transmissions 514, the one or more transmissions 516, the one or more transmissions 524, or the one or more transmissions 526. In response to receiving an LP-SS or an LP-sync preamble signal as the one or more transmissions 516 or the one or more transmissions 526 to the LPR of the UE 502, the UE 502 may be configured to correct a frequency drift or a time drift based on the received signal.

The UE 502 may have a power savings mode. In some aspects, the power savings mode may be based on a current amount of available power at the UE 502, a predicted amount of available power at the UE 502 over a period of time, a current battery storage state at the UE 502, a predicted battery storage state at the UE 502 after a period of time, a current energy storage state at the UE 502, or a predicted energy storage state at the UE 502 after a period of time. In some aspects, the power savings mode may be based on a charging rate, a discharging rate, or a power consumption rate at the UE 502. In some aspects the predicted amount of available power, predicted battery storage state, or the predicted energy storage state at the UE 502 may be based on the charging rate at the UE 502 if the UE 502 is plugged in, on the discharging rate at the UE 502, and/or a power consumption rate at the UE 502. For example, the UE 502 may switch to a full power mode if a measured or predicted value is greater than or equal to a threshold, and a low-power mode if a measured or predicted value is less than or equal to a threshold. The UE 502 may switch a component, such as a HW component, SW component, FW component, or RF component, to an off mode or a sleep mode to save power when the UE 502 switches to a low-power mode, or a sleep mode. In some aspects, the UE 502 may switch one or more sets of clocks to an off mode or a sleep mode when the UE 502 switches to a low-power mode.

The UE 502 or the network node 504 may indicate one or more sets of clocks to switch to an off mode or a sleep mode when the UE 502 switches to a low-power mode. For example, during a low-power mode, the UE 502 may switch off all clocks except for a clock having a minimum accuracy (a frequency drift or a frequency error less than or equal to a threshold value) having the lowest power consumption, and may associate all radios of the UE 502 to use that clock. The set of clocks may be selected based on any of the one or more parameters of the UE 502, for example an RRC mode and a predicted amount of available power at the UE 502. The UE 502 may be configured to use a first clock having a lower frequency drift during an RRC connected mode and a second clock having a higher frequency drift during an RRC idle mode or a paging mode. In some aspects, the network node 504 may configure a set of parameters for an LP signal, such as an LP-RS, LP-SS, LP-WUS, or an LP-sync-preamble, based on the selected clock.

In some aspects, the UE 502 may transmit an LP-sync preamble signal as the LP signal 510 to the UE 502. The LP-sync preamble signal may be a type of synchronization signal. The LP-sync preamble signal may be similar to an LP-SS, but may have a different configuration or sequence. The UE 502 may use the LP-sync preamble signal to do finer synchronization than with the LP-SS. In some aspects, the network node 504 may repeatedly transmit the LP-SS to the UE 502, similar to repeatedly transmitting its SSB. In some aspects, the network node 504 may transmit the LP-sync preamble signal with an LP-WUS. The network node 504 may schedule its transmissions of LP-WUS to optionally be transmitted with an LP-sync preamble signal, such that the network node 504 may transmit the LP signal 510 as an LP-WUS without an LP-sync preamble signal or as an LP-WUS with an LP-sync preamble signal.

The network node 504 may configure resources to an LP-sync preamble, or may configure resource sets to an LP-sync preamble. Each resource or resource set may be configured with at least one of an ID, a scrambling ID, a QCL source, or a TCI state. In some aspects, the network node 504 may associate an LP-sync preamble with an LP-WUS using an ID of the LP-sync preamble and an ID of the LP-WUS. The network node 504 may dynamically allocate a size to the LP-sync preamble based on an estimated accuracy of a clock associated with the LP-sync preamble. For example, a first estimated accuracy of a clock may be associated with a first size of the LP-sync preamble and a second estimated accuracy of the clock may be associated with a second size of the LP-sync preamble, where a greater accuracy may be associated with a smaller size of the LP-sync preamble. The network node 504 may estimate the accuracy of a clock based on a time duration since the network node 504 has transmitted an LP-SS or an LP-sync preamble to the UE 502 associated with the clock. In some aspects, the network node 504 may estimate the accuracy of clock based on an RRC state (RRC connected, RRC inactive, RRC idle) of the UE 502, or a UE mode (full power, low power, sleep) of the UE 502. The network node 504 may configure an LP-sync preamble based on a previous LP-SS transmitted by the network node 504 to the UE 502, for example based on a size of the LP-SS or a time of the LP-SS.

In some aspects, the network node 504 may configure the LP-sync preamble separately from an LP-WUS that is associated with the LP-sync preamble. In other aspects, the network node 504 may configure the LP-sync preamble while configuring the LP-WUS that is associated with the LP-sync preamble (e.g., within a configuration of the LP-WUS resource or the LP-WUS resource set). In some aspects, the network node 504 may indicate a size of an LP-sync-preamble associated with each LP-WUS or LP-WUS occasion in the resource of the LP-WUS. In some aspects, an LP-WUS occasions of an LP-WUS resource may be associated with LP-sync preamble of a specific size/length/configuration.

In some aspects, the UE 502 may use an LP-SS for LP-WUR synchronization with the serving cell, serving cell radio resource management (RRM) measurements, serving cell radio link management (RLM) measurements, and/or for neighbor cell RRM measurements. In some aspects, the UE 502 may use an LP-SS for a time and frequency error estimation and correction for the serving cell signals. In some aspects, the UE 502 may use an LP-SS for inter-frequency frequency serving cell RRM measurements, intra-frequency serving cell RRM measurements, inter-frequency serving cell RLM measurements, intra-frequency serving cell RLM measurements, inter-frequency neighbor cell RRM measurements, and/or intra-frequency neighbor cell RRM measurements. In some aspects, the UE may use an LP-sync-preamble signal for synchronization to help in receiving the LP-WUS or to refine the synchronization after receiving the LP-SS. In some aspects, the network node 504 may configure the LP-sync-preamble signal resource as part of its LP-WUS resource configurations at 508. In other aspects, the network node 504 may configure the LP-sync-preamble signal resource is configured separately from an LP-WUS resource configuration that the LP-sync-preamble signal resource is associated with. For example, the network node 504 may pre-configure the LP-sync-preamble resource in an RRC, and may configure the LP-WUS resource at 508. The network node 504 may associate an LP-sync-preamble signal resource with at least one of LP-WUS resource or resource set. In some aspects, the network node 504 may configure an LP resource set having at least one of an LP-SS resource, an LP-RS resource, an LP-WUS resource, or an LP-sync-preamble signal resource. In some aspects, the network node 504 may associate each LP-SS/LP-RS with a type of an LP-SS, or a type of an LP-RS. The type of the LP-SS or the type of LP-RS may include, for example, a synchronization of an LP-WUR to receive LP-WUS from a serving cell, a synchronization of an LP-WUR to receive RRM/RLM for a serving cell, or a synchronization of an LP-WUR to receive RRM for one or more neighbor cells.

In some aspects, the network node 504 may configure resources for one LP signal within another LP signal. For example, the network node 504 may configure a resource set for an LP-WUS or an LP-WUR, and may configure within that resource set a resource set for at least one of an LP-WUS, an LP-SS, an LP-RS, or an LP-sync preamble. In other words, at least one of the ID, QCL, TCI state, or scrambling ID may be the same between resources for one LP signal and resources for another LP signal.

In some aspects, a network may assign distinct cell IDs to different radios of the UE 502. For example, the network may associate a first cell ID with the HPR of the UE 502 and associate a second cell ID with the LPR of the UE 502. The first cell ID may be different from the second cell ID. The network node 504 may associate the cell IDs at 508. The network node 504 may transmit a set of cell IDs to the LPR of the UE 502 as the LP signal 510 or to the HPR of the UE 502 as the HP signal 520. The network node 504 may transmit the LP signal 510 or the HP signal 520 as a primary synchronization signal (PSS) or as a secondary synchronization signal (SSS) that includes the set of cell IDs. The UE 502 may receive the set of cell IDs, which may allow the UE 502 to search for cells having the cell IDs. The network node 504 may transmit the set of cell IDs to a plurality of other UEs, allowing the other UEs to search for the HPR of the UE 502 or the LPR of the UE 502 as distinct cells separate from one another. The set of cell IDs may include cell IDs of neighbor cells, allowing the UE 502 to search for certain IDs instead of searching for all IDs. The UE 502 may configure its LPR using a set of cell IDs received at its HPR. The cell ID associated with the LPR of the UE 502 may be different than the cell ID associated with the HPR of the UE 502. For example, the network node 504 may assign a first cell ID for a set of synchronization signal blocks (SSBs), which may be received by the HPR of the UE 502, and a second cell ID for a set of LP signals, which may be received by the LPR of the UE 502. The LP signals may include, for example, an LP-WUS, an LP-RS, an LP-SS, or an LP-sync preamble signal. The LP-sync preamble signal may be associated with, and/or transmitted with, the LP-WUS. In some aspects, a network node may transmit an SSB with a set of LP-WUS resources, a set of LP-WUS resource sets, a set of LP-RS resources, a set of LP-RS resource sets, a set of LP-sync preamble signal resources, a set of LP-sync preamble signal resource sets, a set of LP-SS resources, and/or a set of LP-SS resource sets. In other words, an SSB beam may be used for transmitting multiple LP signal occasions, resources, or resource sets.

In some aspects, the network node 504 may transmit a QCL source as an RS to the UE 502. For example, the network node 504 may transmit a QCL source as an SSB, SCI-RS, or SRS to the HPR of the UE 502 as the one or more transmissions 514 or the one or more transmissions 524. In another example, the network node 504 may transmit a QCL source as an LP-RS or an LP-SS to the LPR of the UE 502 as the one or more transmissions 516 or the one or more transmissions 526. The UE 502 may receive the QCL source. The UE 502 may determine one or more channel characteristics, adjust an Rx beam, or adjust a filter based on the QCL source. The QCL source may be different for each resource. The QCL source may be different for each of a plurality of resources within a set of resources. Each of the transmitted resources may be repeated during a transmission. Each resource set may be repeated during a transmission.

In summary, the network node 504 may use the LP signal 510 and/or the HP signal 520 to dynamically instruct the UE 502 to turn off Rx or Tx at its HPR and/or its LPR, and to dynamically switch any Rx or Tx components to a sleep mode to save power. The UE 502 may be configured to dynamically offload communications using its HPR to its LPR to save power and/or to save time.

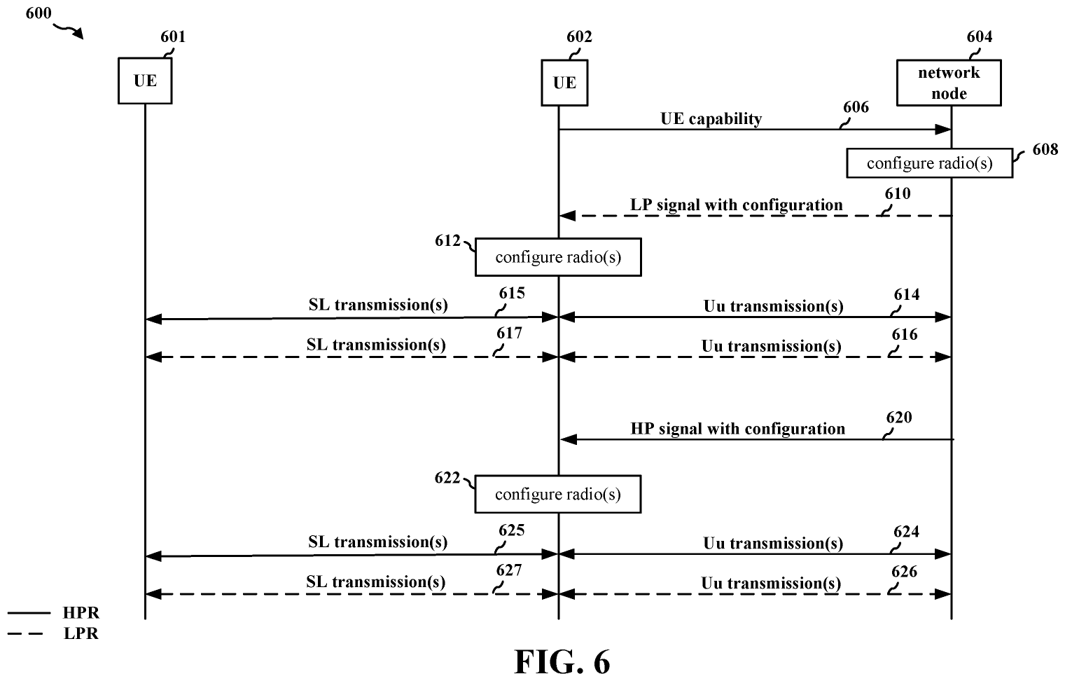

FIG. 6 is a communication flow diagram 600 illustrating a UE 602 configured to communicate with a network node 604 and/or a UE 601 using an HPR and/or an LPR. The HPR of the UE 602 may be, for example, the radio 406 in FIGS. 4A and 4B. The LPR of the UE 602 may be, for example, the radio 408 in FIGS. 4A and 4B. The LPR may have a lower power consumption than the HPR. The LPR may communicate using a different set of resources than the HPR. For example, the HPR may use a larger bandwidth than the LPR, or the HPR may use less power to transmit communications than the LPR. Communication using a set of resources associated with the HPR of the UE 602 are shown with a solid line. Communication using a set of resources associated with the LPR of the UE 602 are shown using a dotted line.

The UE 602 may transmit a UE capability 606 to the network node 604 using its HPR. The network node 604 may receive the UE capability 606 from the HPR of the UE 602. The UE capability 606 may include an indicator of a simultaneous connectivity capability of the UE 602. In other words, the UE capability 606 may indicate to the network node 604 that the UE 602 is capable of simultaneously communicating with wireless devices using its HPR and its LPR. Communicating with a wireless device may include transmitting a signal to the wireless device or receiving a signal from the wireless device. The indicator of the simultaneous connectivity capability may be UE specific, band specific, component carrier (CC) specific, a combination of bands, or a combination of CCs. In other words, the indicator of the simultaneous connectivity capability may indicate to the network node 604 an identifier of the UE 602, one or more bands that the UE 602 may use to communicate signals using its HPR, one or more bands that the UE 602 may use to communicate signals using its LPR, one or more CCs that the UE 602 may use to communicate signals using its HPR, and/or one or more CCs that the UE 602 may use to communicate signals using its LPR. The UE capability 606 may also include an indicator of whether the LPR of the UE 602 may communicate one or more signals that the HPR of the UE 602 may communicate, allowing the network node 604 to understand which signals may be offloaded from the HPR of the UE 602 to the LPR of the UE 602. The UE capability 606 may communicate one or more clock parameters of a set of clocks associated with the UE 602, such as the set of clocks 407 and/or the set of clocks 409 in FIGS. 4A and 4B. The clock parameters may include, for example, a frequency drift (in terms of parts per million per second, or ppm/s) and/or a maximum frequency drift. For example, the UE 602 may characterize a clock as having a frequency drift of ±0.05 ppm/s and a maximum frequency drift of 2 ppm. In some aspects, the UE capability 606 may include a device type of the UE 602. For example, the UE capability 606 may include an indicator that the UE 602 is a type of smart phone or that the UE 602 is a type of RedCap device. In some aspects, the UE capability 606 may include an indicator of a type of connection that the UE 602 is capable of making. For example, the UE capability 606 may include an indicator that the UE 602 is capable of making a RedCap connection, an eRedCap connection, a Uu connection, a sidelink connection, or a non-RedCap connection. In some aspects, the UE 602 may be configured to support both a smart phone function and a RedCap function.

At 608, the network node 604 may configure the HPR of the UE 602, the LPR of the UE 602, or both the HPR and the LPR of the UE 602. The configuration may be based on the UE capability 606. For example, if the UE 602 indicates via the UE capability 606 that it is capable of simultaneously communicating with both the HPR and the LPR of the UE 602, the network node 604 may configure the UE 602 to communicate with both the HPR and the LPR simultaneously, offloading some of the communication transmissions from the HPR to the LPR. If the UE 602 indicates via the UE capability 606 that it is not capable of simultaneously communicating with both the HPR and the LPR of the UE 602, the network node 604 may configure the UE 602 to communicate with the HPR during a first period of time, and the LPR for a second period of time, and switch the HPR to a sleep mode during the second period of time.

In one aspect, if the UE capability 606 indicates that the UE 602 supports a RedCap function and does not support a smart phone function, the network node 604 may use relaxed requirements for UE complexity and/or may use a relaxed processing timeline. In some aspects, the network node 604 may use a smaller bandwidth for a UE that supports a RedCap function and does not support a smart phone function than a UE that supports a smart phone function, may use one carrier for a UE that supports a RedCap function and does not support a smart phone function than a UE that supports a smart phone function, may use a smaller number of Tx and/or Rx antennas for a UE that supports a RedCap function and does not support a smart phone function than a UE that supports a smart phone function, or may use a smaller number of MIMO layers for a UE that supports a RedCap function and does not support a smart phone function than a UE that supports a smart phone function. In some aspects, the network node 604 may use a relaxed processing timeline for data scheduling, processing, HARQ-ACK feedback, or CSI processing for a UE that supports a RedCap function and does not support a smart phone function than a UE that supports a smart phone function.

The network node 604 may transmit a signal with a configuration for the HPR and/or the LPR of the UE 602. The signal may be transmitted to the LPR or to the HPR. In one aspect, the network node 604 may transmit an LP signal 610 with a configuration for the HPR and/or the LPR of the UE 602 to the LPR of the UE 602. The UE 602 may receive the LP signal 610 with a configuration for the HPR and/or the LPR of the UE 602 from the network node 604 via the LPR of the UE 602. The LP signal 610 with a configuration for the HPR and/or the LPR of the UE 602 transmitted to the LPR of the UE 602 may have an indicator of whether to use the HPR and/or the LPR of the UE 602 for connected mode during a time period. The LP signal 610 may be an LP-WUS that includes an indicator to both wake-up the HPR and to either switch the LPR to sleep mode, keep the LPR in a periodic active mode, or switch the LPR to an active mode. The LP-WUS may have an indicator for each of the HPR and the LPR. The indictor may indicate for the UE 602 to wake up transmission components of the radio and not to wake up reception components of the radio, to wake up reception components of the radio and not to wake up transmission components of the radio, to wake up both transmission and reception components of the radio, to wake up transmission components of the radio for Uu communication with the network node 604 and not to wake up transmission components of the radio for sidelink communication with the UE 601, to wake up reception components of the radio for Uu communication with the network node 604 and not to wake up reception components of the radio for sidelink communication with the UE 601, to wake up transmission and reception components of the radio for Uu communication with the network node 604 and not to wake up transmission and reception components of the radio for sidelink communication with the UE 601, to wake up transmission components of the radio for sidelink communication with the network node 604 and not to wake up transmission components of the radio for Uu communication with the UE 601, to wake up reception components of the radio for sidelink communication with the network node 604 and not to wake up reception components of the radio for Uu communication with the UE 601, and/or to wake up transmission and reception components of the radio for sidelink communication with the network node 604 and not to wake up transmission and reception components of the radio for Uu communication with the UE 601.

The LP signal 610 with a configuration for the HPR and/or the LPR of the UE 602 transmitted to the LPR of the UE 602 may have an indicator of whether to switch any of the components of the HPR and/or the LPR of the UE 602 to a sleep mode for a time period. The LP signal 610 may be an LP go-to-sleep (LP-GTP) signal having an indicator for the UE 602 to switch transmission components of a radio to a sleep mode, to switch reception components of a radio to a sleep mode, to switch both transmission and reception components of a radio to a sleep mode, to switch transmission components of a radio to a sleep mode for Uu communication with the network node 604 but not to sleep mode for sidelink communication with the UE 601, to switch reception components of a radio to a sleep mode for Uu communication with the network node 604 but not to sleep mode for sidelink communication with the UE 601, to switch both transmission and reception components of a radio to a sleep mode for Uu communication with the network node 604 but not to sleep mode for sidelink communication with the UE 601, to switch transmission components of a radio to a sleep mode for sidelink communication with the UE 601 but not to sleep mode for Uu communication with the network node 604, to switch reception components of a radio to a sleep mode for sidelink communication with the UE 601 but not to sleep mode for Uu communication with the network node 604, and/or to switch transmission and reception components of a radio to a sleep mode for sidelink communication with the UE 601 but not to sleep mode for Uu communication with the network node 604.

At 612, the UE 602 may configure the HPR and/or the LPR of the UE 602 using the LP signal 610. The LP signal 610 may include a configuration for the HPR. In other words, the UE 602 may receive the LP signal 610 via its LPR, and may use the LP signal 610 to configure its HPR. The UE 602 may configure its HPR using the configuration of the LP signal 610. The UE 602 may communicate the one or more Uu transmissions 614 with the network node 604 via its HPR based on the configuration of the LP signal 610. The one or more Uu transmissions 614 may use a Uu connection between the UE 602 and the network node 604. The UE 602 may communicate the one or more sidelink transmissions 615 with the UE 601 via its HPR based on the configuration of the LP signal 610. The one or more sidelink transmissions 615 may use a sidelink connection between the UE 602 and the UE 601. The LP signal 610 may include a configuration for the LPR. The UE 602 may configure its LPR using the configuration of the LP signal 610. The UE 602 may communicate the one or more Uu transmissions 616 with the network node 604 via its LPR based on the configuration of the LP signal 610. The one or more Uu transmissions 616 may use a Uu connection between the UE 602 and the network node 604. The UE 602 may communicate the one or more sidelink transmissions 617 with the UE 601 via its LPR based on the configuration of the LP signal 610. The one or more sidelink transmissions 617 may use a sidelink connection between the UE 602 and the UE 601.

In one aspect, the network node 604 may transmit the HP signal 620 with a configuration for the HPR and/or the LPR of the UE 602 to the HPR of the UE 602. The UE 602 may receive the HP signal 620 with a configuration for the HPR and/or the LPR of the UE 602 from the network node 604 via the HPR of the UE 602. At 622, the UE 602 may configure the HPR and/or the LPR of the UE 602 using the HP signal 620. The HP signal 620 may include a configuration for the LPR. In other words, the UE 602 may receive the HP signal 620 via its HPR, and may use the HP signal 620 to configure its LPR. The UE 602 may configure its LPR using the configuration of the HP signal 620.

The HP signal 620 may be a wake-up signal that includes an indicator to both wake-up the LPR and to either switch the HPR to sleep mode or keep the HPR in an active mode. The wake-up signal may have an indicator for each of the HPR and the LPR. The indictor may indicate for the UE 602 to wake up transmission components of the radio and not to wake up reception components of the radio, to wake up reception components of the radio and not to wake up transmission components of the radio, to wake up both transmission and reception components of the radio, to wake up transmission components of the radio for Uu communication with the network node 604 and not to wake up transmission components of the radio for sidelink communication with the UE 601, to wake up reception components of the radio for Uu communication with the network node 604 and not to wake up reception components of the radio for sidelink communication with the UE 601, to wake up transmission and reception components of the radio for Uu communication with the network node 604 and not to wake up transmission and reception components of the radio for sidelink communication with the UE 601, to wake up transmission components of the radio for sidelink communication with the network node 604 and not to wake up transmission components of the radio for Uu communication with the UE 601, to wake up reception components of the radio for sidelink communication with the network node 604 and not to wake up reception components of the radio for Uu communication with the UE 601, and/or to wake up transmission and reception components of the radio for sidelink communication with the network node 604 and not to wake up transmission and reception components of the radio for Uu communication with the UE 601.

The HP signal 620 with a configuration for the HPR and/or the LPR of the UE 602 transmitted to the HPR of the UE 602 may have an indicator of whether to switch any of the components of the HPR and/or the LPR of the UE 602 to a sleep mode for a time period. The HP signal 620 may be a go-to-sleep signal having an indicator for the UE 602 to switch transmission components of a radio to a sleep mode, to switch reception components of a radio to a sleep mode, to switch both transmission and reception components of a radio to a sleep mode, to switch transmission components of a radio to a sleep mode for Uu communication with the network node 604 but not to sleep mode for sidelink communication with the UE 601, to switch reception components of a radio to a sleep mode for Uu communication with the network node 604 but not to sleep mode for sidelink communication with the UE 601, to switch both transmission and reception components of a radio to a sleep mode for Uu communication with the network node 604 but not to sleep mode for sidelink communication with the UE 601, to switch transmission components of a radio to a sleep mode for sidelink communication with the UE 601 but not to sleep mode for Uu communication with the network node 604, to switch reception components of a radio to a sleep mode for sidelink communication with the UE 601 but not to sleep mode for Uu communication with the network node 604, and/or to switch transmission and reception components of a radio to a sleep mode for sidelink communication with the UE 601 but not to sleep mode for Uu communication with the network node 604.

The UE 602 may communicate the one or more Uu transmissions 624 with the network node 604 via its HPR based on the configuration of the HP signal 620. The one or more Uu transmissions 624 may use a Uu connection between the UE 602 and the network node 604. The UE 602 may communicate the one or more sidelink transmissions 625 with the UE 601 via its HPR based on the configuration of the HP signal 620. The one or more sidelink transmissions 625 may use a sidelink connection between the UE 602 and the UE 601. The HP signal 620 may include a configuration for the LPR. The UE 602 may configure its LPR using the configuration of the HP signal 620. The UE 602 may communicate the one or more Uu transmissions 626 with the network node 604 via its LPR based on the configuration of the HP signal 620. The one or more Uu transmissions 626 may use a Uu connection between the UE 602 and the network node 604. The UE 602 may communicate the one or more sidelink transmissions 627 with the UE 601 via its LPR based on the configuration of the HP signal 620. The one or more sidelink transmissions 627 may use a sidelink connection between the UE 602 and the UE 601.

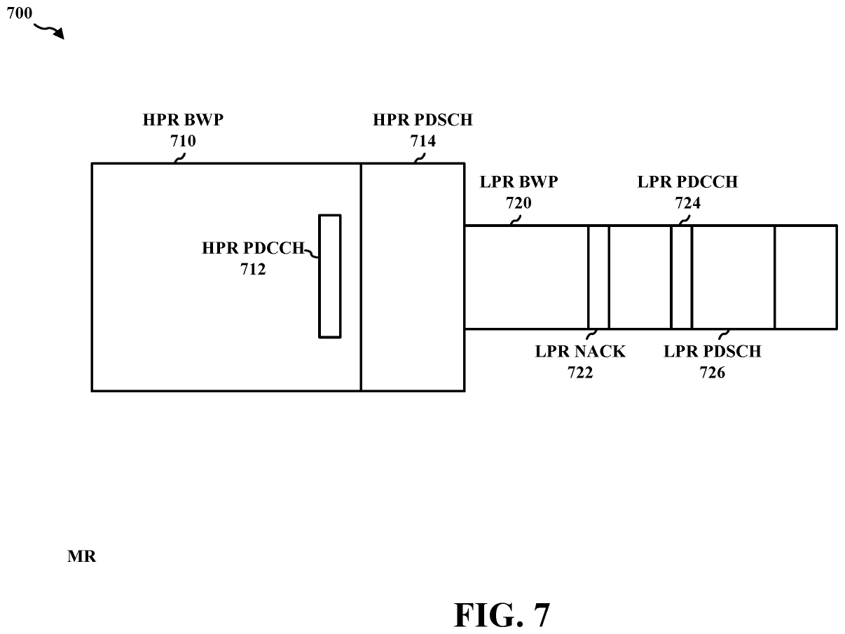

FIG. 7 is a diagram 700 illustrating an example of a transmission schedule between a UE and a network node, such as the UE 502 and the network node 504 in FIG. 5 or the UE 602 and the network node 604 in FIG. 6. The HPR of the UE and the network node may communicate with one another using the HPR BWP 710. The LPR of the UE and the network node may communicate with one another using the LPR BWP 720. The HPR BWP 710 may be larger than the LPR BWP 720. The LPR BWP 720 may be smaller than the HPR BWP 710. In other words, the HPR BWP 710 may cover a larger range of frequencies than the LPR BWP 720. The LPR of the UE may transmit signals using the LPR BWP 720 using a higher amount of power so that the signal strength of a transmission using the LPR BWP 720 is within a threshold value of the signal strength of a transmission using the HPR BWP 710. A network node transmitting signals to the UE via the LPR BWP 720 may transmit signals to the UE using a higher amount of power so that the signal strength of a transmission using the LPR BWP 720 is within a threshold value of the signal strength of a transmission using the HPR BWP 710.

The network node may transmit a PDCCH and a PDSCH to the UE using the HPR BWP 710 and/or using the LPR BWP 720. In some aspects, the network node may schedule the UE to receive a PDCCH and a PDSCH to an HPR of the UE and then for the UE to switch its HPR to a sleep mode. In other words, the network node may schedule the UE to receive a PDCCH and a PDSCH using the HPR BWP 710, but if the UE fails to decode the PDCCH and the PDSCH transmitted using the HPR BWP 710, the network node may not be able to immediately retransmit the PDCCH and the PDSCH using the HPR BWP 710.

In one aspect, the network node may transmit a PDCCH as the HPR PDCCH 712 using the HPR BWP 710 to the HPR of the UE. The network node may transmit a PDSCH as the HPR PDSCH 714 using the HPR BWP 710 to the HPR of the UE. The UE may then switch its HPR to sleep mode. If the UE fails to successfully decode the HPR PDSCH 714, the UE may transmit an LPR NACK 722 using the LPR BWP 720. The UE may not be able to transmit a NACK using the HPR BWP 710, as the HPR may have been switched to a sleep mode. The network node may receive the LPR NACK 722. If the network node can retransmit the PDCCH and the PDSCH using the LPR, the network node may retransmit the PDCCH as the LPR PDCCH 724 using the LPR BWP 720 to the LPR of the UE. The network node may retransmit the PDSCH as the LPR PDSCH 726 using the LPR BWP 720 to the LPR of the UE. The network node may determine whether it may retransmit the PDCCH and the PDSCH based on a UE capability, for example the UE capability 506 in FIG. 5 or the UE capability 606 in FIG. 5. The network node may be configured to retransmit the PDCCH and the PDSCH with a signal that is compatible with the LPR of the UE within its bandwidth, such as the LPR BWP 720. The network node may be configured to retransmit the PDCCH and the PDSCH if the PDSCH fits within the bandwidth of the LPR BWP 720 and if the UE is able to store the data of the PDSCH. For example, the UE may indicate in its UE capability that the LPR has access to a threshold amount of memory. If the PDSCH is larger than the threshold amount of memory, of if the PDSCH added to a set of past data transmissions to the LPR (e.g., data transmissions to the UE since the last time the UE emptied its memory or cleared its cache) is larger than the threshold amount of memory, the network node may cancel the retransmission of the PDSCH. In some aspects, the network node may split the PDSCH into smaller transmissions as compared to the HPR PDSCH 714 in order to accommodate the smaller bandwidth of the LPR BWP 720. For example, the network node may split the set of TBs of the HPR PDSCH 714 into a larger number of a set of smaller TBs for the LPR PDSCH 726. In some aspects, the network node may add additional time resources as compared to the HPR PDSCH 714 for the retransmission in order to accommodate the smaller bandwidth of the LPR BWP 720. For example, the network may allocate a larger amount of time to transmit the LPR PDSCH 726 as compared with the amount of time allocated to transmit the HPR PDSCH 714. The network node may be configured to split the PDSCH into a larger set of TB s or allocate a longer period of time for transmitting the LPR PDSCH 726 in response to determining that the LPR BWP 720 does not have enough resources to transmit the HPR PDSCH 714 without a reallocation of resources and/or time.

In some aspects, the UE may process and/or decode the PDSCH 726 received via the LPR of the UE. For example, the UE may receive the PDSCH 726 via the LPR BWP 720, store the TBs, decode the TBs of the PDSCH 726, and process the data, for example by measuring an RSRP of the PDSCH 726. In other aspects, the UE may wait until a component activates to process and/or decode the PDSCH 726 received via the LPR of the UE. For example, the UE may receive the PDSCH 726 via the LPR BWP 720 and store the TBs. The UE may then decode and process the TBs of the PDSCH 726 in response to the UE switching its HPR to an active mode. In other words, the LPR may store and/or buffer the received data until a component of the UE is switched to an active mode.

If the network node cannot retransmit the PDCCH and the PDSCH using the LPR of the UE, the network node may transmit a signal having an indicator that the network node is unable to retransmit the PDCCH and the PDSCH using the LPR of the UE. Such an indicator may also be referred to as an unable to receive retransmission indicator. The network node may transmit the signal including the indicator that the network is unable to retransmit the PDSCH using the LPR of the UE based on a UE capability, such as the UE capability 506 in FIG. 5 or the UE capability 606 in FIG. 6. In some aspects, the network node may transmit an LP-WUS to the LPR of the UE to wake up the HPR of the UE. The UE may then wake up its HPR to receive the retransmission of the PDCCH and the PDSCH using the HPR BWP 710, thereby receiving the retransmission of the PDCCH and the PDSCH via the HPR of the UE. In some aspects, the network node may reschedule the retransmission of the PDCCH and the PDSCH when the UE switches its HPR from a sleep mode to an active mode. The network node may transmit an LP-RS to the LPR of the UE indicating that it will retransmit the PDCCH and the PDSCH via the HPR of the UE when the HPR is switched to an active mode.

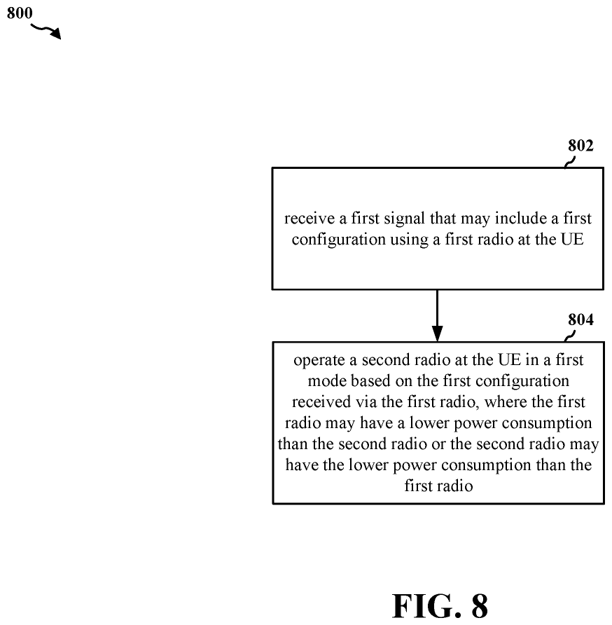

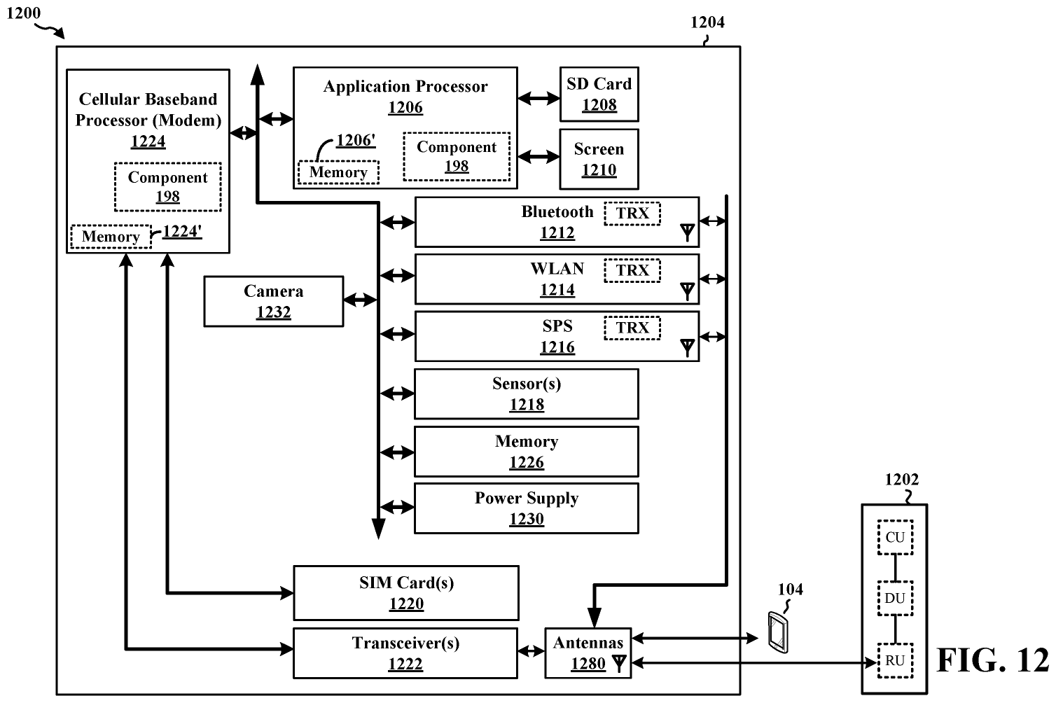

FIG. 8 is a flowchart 800 of a method of wireless communication. The method may be performed by a UE (e.g., the UE 104, the UE 350, the UE 502, the UE 602; the apparatus 1004). At 802, the UE may receive a first signal including a first configuration using a first radio at the UE. For example, 802 may be performed by the UE 502 in FIG. 5, which may receive an LP signal 510 including a configuration for the UE 502 using an LPR at the UE 502. In another example, 802 may be performed by the UE 502 in FIG. 5, which may receive an HP signal 520 including a configuration for the UE 502 using an HPR at the UE 502. Moreover, 802 may be performed by the component 198 in FIG. 12.

At 804, the UE may operate a second radio at the UE in a first mode based on the first configuration received via the first radio. The first radio may have a lower power consumption than the second radio or the second radio may have the lower power consumption than the first radio. For example, 804 may be performed by the UE 502 in FIG. 5, which may operate an HPR at the UE 502 in a transmission mode, a reception mode, or a sleep mode based on the configuration in the LP signal 510 received via the LPR at the UE 502. The LPR may have a lower power consumption than the HPR at the UE 502. In another example, 804 may be performed by the UE 502 in FIG. 5, which may operate an LPR at the UE 502 in a transmission mode, a reception mode, a periodically active mode, or an active mode based on the configuration in the HP signal 520 received via the HPR at the UE 502. The LPR may have a lower power consumption than the HPR at the UE 502. Moreover, 804 may be performed by the component 198 in FIG. 12.

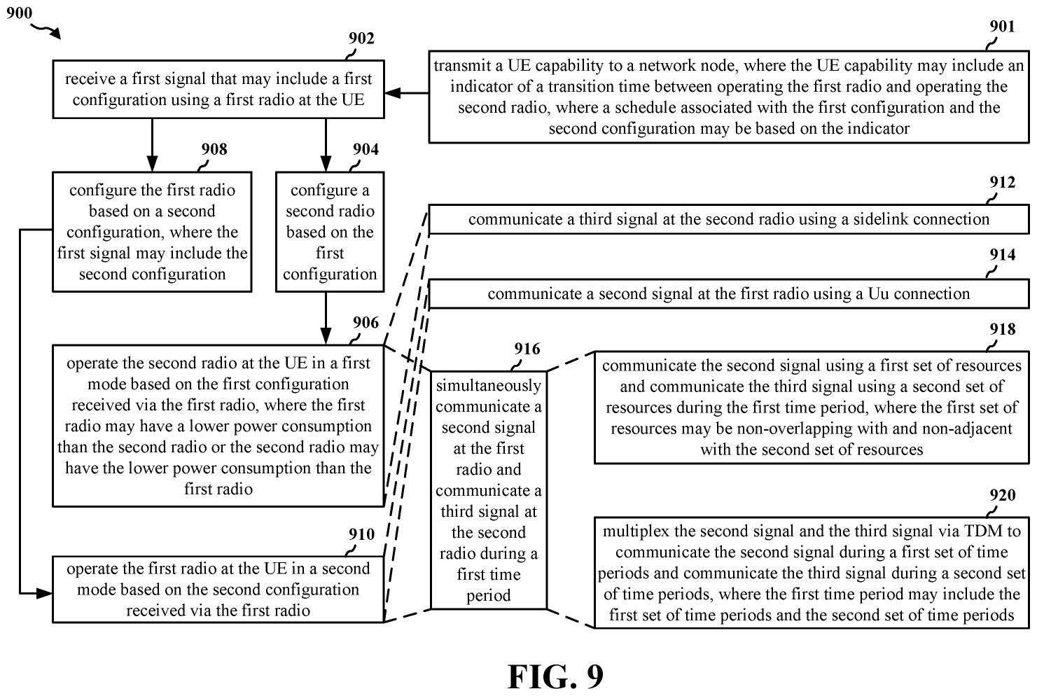

FIG. 9 is a flowchart 900 of a method of wireless communication. The method may be performed by a UE (e.g., the UE 104, the UE 350, the UE 502, the UE 602; the apparatus 1004).

At 901, the UE may transmit a UE capability to a network node. The UE capability may include an indicator of a transition time between operating the first radio and operating the second radio. A schedule associated with the first configuration and the second configuration may be based on the indicator. For example, 901 may be performed by the UE 502 in FIG. 5, which may transmit the UE capability 506 to a network node 504. The UE capability 506 may include an indicator of a transition time between operating the HPR and operating the LPR at the UE 502. A schedule associated with the first configuration and the second configuration may be based on the indicator of the UE capability 506. Moreover, 901 may be performed by the component 198 in FIG. 12.

At 902, the UE may receive a first signal including a first configuration using a first radio at the UE. For example, 902 may be performed by the UE 502 in FIG. 5, which may receive an LP signal 510 including a configuration for the UE 502 using an LPR at the UE 502. In another example, 902 may be performed by the UE 502 in FIG. 5, which may receive an HP signal 520 including a configuration for the UE 502 using an HPR at the UE 502. Moreover, 902 may be performed by the component 198 in FIG. 12.

At 904, the UE may configure a second radio based on the first configuration. For example, 904 may be performed by the UE 502 in FIG. 5, which may configure the HPR of the UE 502 based on the configuration of the LP signal 510. 904 may also be performed by the UE 502 in FIG. 5, which may configure the LPR of the UE 502 based on the configuration of the HP signal 520. Moreover, 904 may be performed by the component 198 in FIG. 12.

At 906, the UE may operate the second radio at the UE in a first mode based on the first configuration received via the first radio. The first radio may have a lower power consumption than the second radio or the second radio may have the lower power consumption than the first radio. For example, 906 may be performed by the UE 502 in FIG. 5, which may operate an HPR at the UE 502 in a transmission mode, a reception mode, or a sleep mode based on the configuration in the LP signal 510 received via the LPR at the UE 502. The LPR may have a lower power consumption than the HPR at the UE 502. In another example, 906 may be performed by the UE 502 in FIG. 5, which may operate an LPR at the UE 502 in a transmission mode, a reception mode, a periodically active mode, or an active mode based on the configuration in the HP signal 520 received via the HPR at the UE 502. The LPR may have a lower power consumption than the HPR at the UE 502. Moreover, 906 may be performed by the component 198 in FIG. 12.

At 908, the UE may configure the first radio based on a second configuration. The first signal may include the second configuration. For example, 908 may be performed by the UE 502 in FIG. 5, which may configure the LPR of the UE 502 based on the configuration of the LP signal 510. 904 may also be performed by the UE 502 in FIG. 5, which may configure the HPR of the UE 502 based on the configuration of the HP signal 520. The first signal may include the second configuration. Moreover, 908 may be performed by the component 198 in FIG. 12.

At 910, the UE may operate the first radio at the UE in a second mode based on the second configuration received via the first radio. For example, 910 may be performed by the UE 502 in FIG. 5, which may operate the HPR at the UE in a mode based on the configuration of the HP signal 520 received by the HPR at the UE 502. 910 may also be performed by the UE 502 in FIG. 5, which may operate the LPR at the UE in a mode based on the configuration of the LP signal 510 received by the LPR at the UE 502. Moreover, 910 may be performed by the component 198 in FIG. 12.

At 912, the UE may communicate a third signal at the second radio using a sidelink connection. For example, 910 may be performed by the UE 602 in FIG. 6, which may communicate the one or more sidelink transmissions 615 at its HPR using a sidelink connection with the UE 601. 910 may also be performed by the UE 602 in FIG. 6, which may communicate the one or more sidelink transmissions 625 at its HPR using a sidelink connection with the UE 601. 910 may also be performed by the UE 602 in FIG. 6, which may communicate the one or more sidelink transmissions 617 at its LPR using a sidelink connection with the UE 601. 910 may also be performed by the UE 602 in FIG. 6, which may communicate the one or more sidelink transmissions 627 at its LPR using a sidelink connection with the UE 601. Moreover, 910 may be performed by the component 198 in FIG. 12.

At 914, the UE may communicate a second signal at the first radio using a Uu connection. For example, 914 may be performed by the UE 602 in FIG. 6, which may communicate the one or more Uu transmissions 614 at its HPR using a Uu connection with the network node 604. 914 may also be performed by the UE 602 in FIG. 6, which may communicate the one or more Uu transmissions 624 at its HPR using a Uu connection with the network node 604. 914 may also be performed by the UE 602 in FIG. 6, which may communicate the one or more Uu transmissions 616 at its LPR using a Uu connection with the network node 604. 914 may also be performed by the UE 602 in FIG. 6, which may communicate the one or more Uu transmissions 626 at its LPR using a Uu connection with the network node 604.

At 916, the UE may simultaneously communicate a second signal at the first radio and communicate a third signal at the second radio during a first time period. For example, 916 may be performed by the UE 502 in FIG. 5, which may simultaneously communicate the one or more transmissions 514 at its HPR and communicate the one or more transmissions 516 at its LPR during a time period. Moreover, 916 may be performed by the component 198 in FIG. 12.

At 918, the UE may communicate the second signal using a first set of resources and communicate the third signal using a second set of resources during the first time period. The first set of resources may be non-overlapping with and non-adjacent with the second set of resources. For example, 918 may be performed by the UE 502 in FIG. 5, which may communicate the one or more transmissions 514 at its HPR using a first set of resources and communicate the one or more transmissions 516 at its LPR using a second set of resources during the same time period. The first set of resources may be non-overlapping with and non-adjacent with the second set of resources. Moreover, 918 may be performed by the component 198 in FIG. 12.

At 920, the UE may multiplex the second signal and the third signal via TDM to communicate the second signal during a first set of time periods and communicate the third signal during a second set of time periods. The first time period may include the first set of time periods and the second set of time periods. For example, 920 may be performed by the UE 502 in FIG. 5, which may multiplex the one or more transmissions 514 at its HPR and the one or more transmissions 516 at its LPR via TDM to communicate the one or more transmissions 514 at its HPR during a first set of time periods and communicate the one or more transmissions 516 at its LPR during a second set of time periods. The time period that the UE 502 uses to communicate the one or more transmissions 514 and the one or more transmissions 516 may include the first set of time periods and the second set of time periods. Moreover, 920 may be performed by the component 198 in FIG. 12.

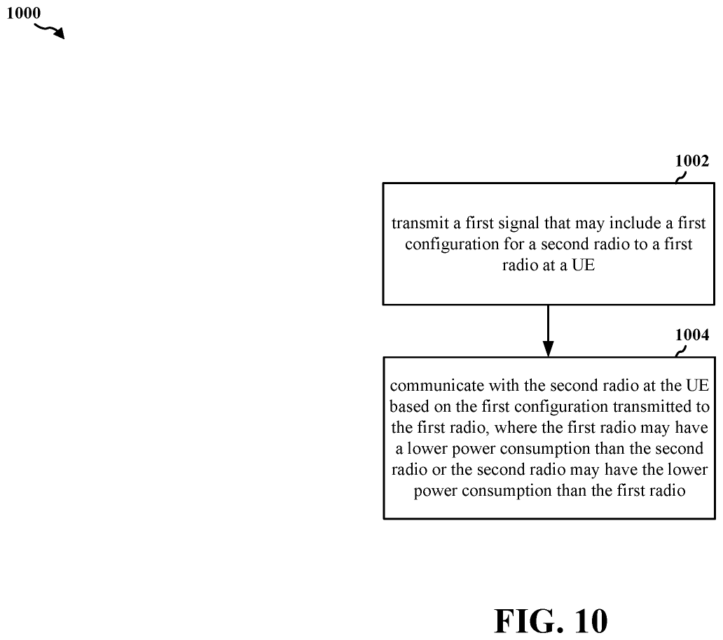

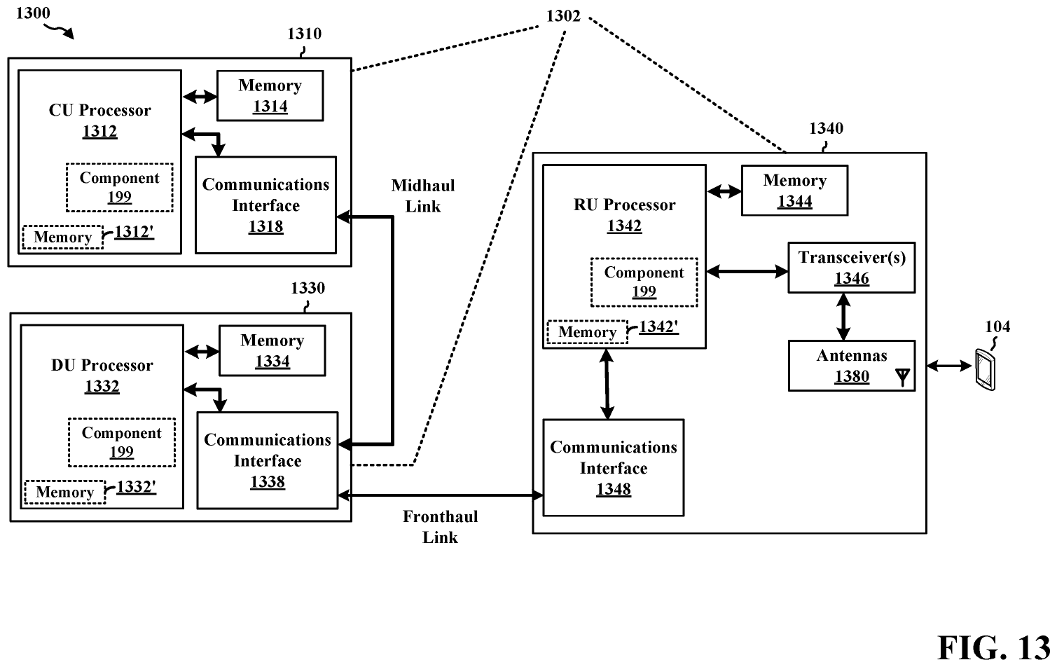

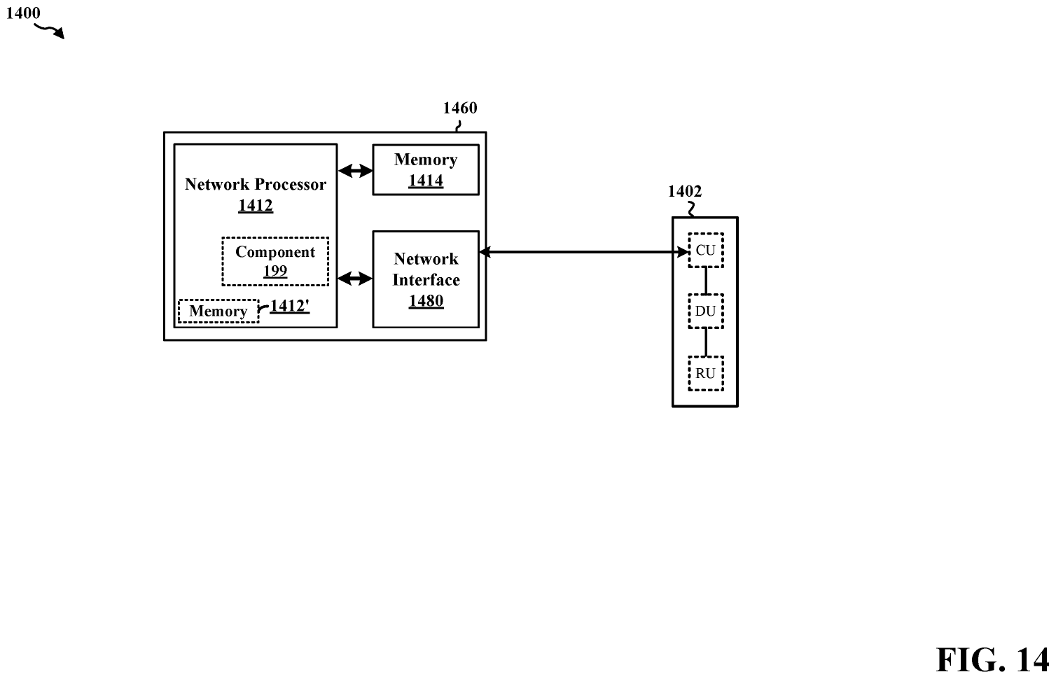

FIG. 10 is a flowchart 1000 of a method of wireless communication. The method may be performed by a network node (e.g., the base station 102, the base station 310; the network node 504, the network node 604; the network entity 1202, the network entity 1302, the network entity 1460). At 1002, the network node may transmit a first signal including a first configuration for a second radio to a first radio at a UE. For example, 1002 may be performed by the network node 504 in FIG. 5, which may transmit an LP signal 510 including a configuration for an HPR to an LPR at the UE 502. In another example, 1002 may be performed by the network node 504 in FIG. 5, which may transmit an HP signal 520 including a configuration for an LPR to an HPR at the UE 502. Moreover, 1002 may be performed by the component 199 in FIG. 13 or 14.

At 1004, the network node may communicate with the second radio at the UE based on the first configuration transmitted to the first radio. The first radio may have a lower power consumption than the second radio or the second radio may have the lower power consumption than the first radio. For example, 1004 may be performed by the network node 504 in FIG. 5, which may communicate with the HPR at the UE 502 based on the configuration in the LP signal 510 transmitted to the LPR at the UE 502. The LPR may have a lower power consumption than the HPR at the UE 502. In another example, 1004 may be performed by the network node 504 in FIG. 5, which may communicate with the LPR at the UE 502 based on the configuration in the HP signal 520 transmitted to the HPR at the UE 502. The LPR may have the lower power consumption than the HPR at the UE 502. Moreover, 1004 may be performed by the component 199 in FIG. 13 or 14.

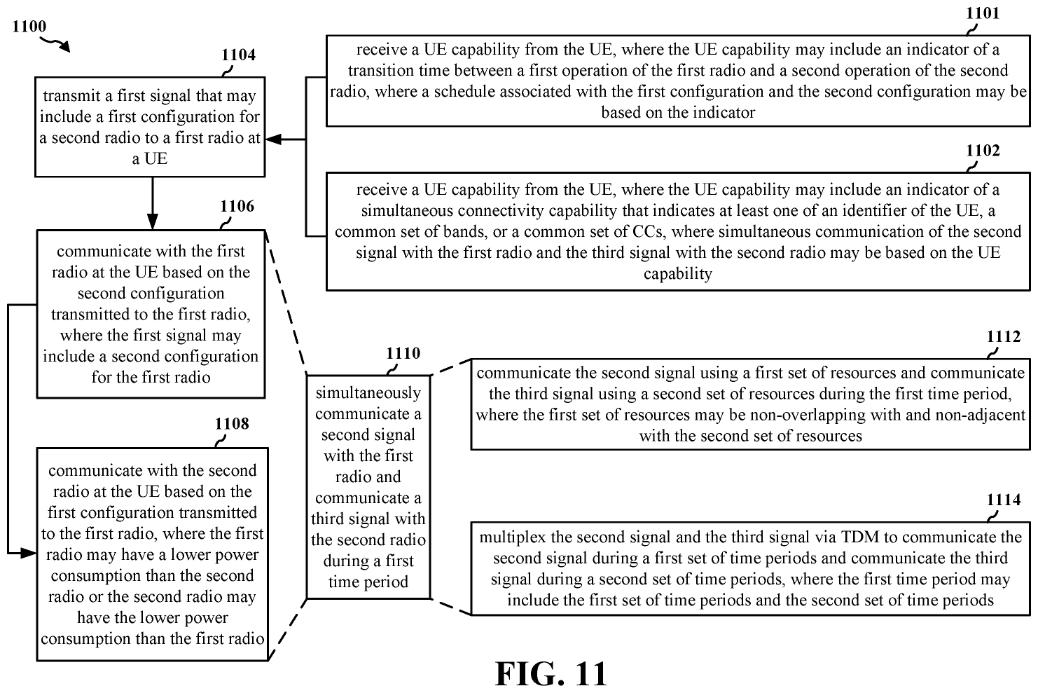

FIG. 11 is a flowchart 1100 of a method of wireless communication. The method may be performed by a network node (e.g., the base station 102, the base station 310; the network node 504, the network node 604; the network entity 1202, the network entity 1302, the network entity 1460).

At 1101, the UE may receive a UE capability from the UE. The UE capability may include an indicator of a transition time between a first operation of the first radio and a second operation of the second radio. A schedule associated with the first configuration and the second configuration may be based on the indicator. For example, 1101 may be performed by the UE 502 in FIG. 5, which may receive the UE capability 506 from the UE 502. The UE capability may include an indicator of a transition time between a first operation of the HPR at the UE 502 and a second operation of the LPR at the UE 502. A schedule associated with the first configuration and the second configuration may be based on the indicator. Moreover, 1101 may be performed by the component 198 in FIG. 12.

At 1102, the UE may receive a UE capability from the UE. The UE capability may include an indicator of a simultaneous connectivity capability that indicates at least one of an identifier of the UE, a common set of bands, or a common set of CCs. Simultaneous communication of the second signal with the first radio and the third signal with the second radio may be based on the UE capability. For example, 1102 may be performed by the UE 502 in FIG. 5, which may receive the UE capability 506 from the UE 502. The UE capability 506 may include an indicator of a simultaneous connectivity capability that indicates at least one of an identifier of the UE, a common set of bands, or a common set of CCs. Simultaneous communication of the one or more transmissions 514 with the HPR at the UE 502 and the one or more transmissions 516 with the LPR at the UE 502 may be based on the UE capability 506. Simultaneous communication of the one or more transmissions 524 with the HPR at the UE 502 and the one or more transmissions 526 with the LPR at the UE 502 may be based on the UE capability 506. Moreover, 1102 may be performed by the component 198 in FIG. 12.

At 1104, the network node may transmit a first signal including a first configuration for a second radio to a first radio at a UE. For example, 1104 may be performed by the network node 504 in FIG. 5, which may transmit an LP signal 510 including a configuration for an HPR to an LPR at the UE 502. In another example, 1104 may be performed by the network node 504 in FIG. 5, which may transmit an HP signal 520 including a configuration for an LPR to an HPR at the UE 502. Moreover, 1104 may be performed by the component 199 in FIG. 13 or 14.

At 1106, the UE may communicate with the first radio at the UE based on the second configuration transmitted to the first radio. The first signal may include a second configuration for the first radio. For example, 1106 may be performed by the UE 502 in FIG. 5, which may communicate with the HPR at the UE 502 based on the configuration of the LP signal 510 transmitted from the network node 504 to the UE 502. The LP signal 510 may include a configuration for the HPR. 1106 may also be performed by the UE 502 in FIG. 5, which may communicate with the LPR at the UE 502 based on the configuration of the LP signal 510 transmitted from the network node 504 to the UE 502. The LP signal 510 may include a configuration for the LPR. 1106 may also be performed by the UE 502 in FIG. 5, which may communicate with the HPR at the UE 502 based on the configuration of the HP signal 520 transmitted from the network node 504 to the UE 502. The HP signal 520 may include a configuration for the HPR. 1106 may also be performed by the UE 502 in FIG. 5, which may communicate with the LPR at the UE 502 based on the configuration of the HP signal 520 transmitted from the network node 504 to the UE 502. The HP signal 520 may include a configuration for the LPR. Moreover, 1106 may be performed by the component 198 in FIG. 12.

At 1108, the network node may communicate with the second radio at the UE based on the first configuration transmitted to the first radio. The first radio may have a lower power consumption than the second radio or the second radio may have the lower power consumption than the first radio. For example, 1108 may be performed by the network node 504 in FIG. 5, which may communicate with the HPR at the UE 502 based on the configuration in the LP signal 510 transmitted to the LPR at the UE 502. The LPR may have a lower power consumption than the HPR at the UE 502. In another example, 1108 may be performed by the network node 504 in FIG. 5, which may communicate with the LPR at the UE 502 based on the configuration in the HP signal 520 transmitted to the HPR at the UE 502. The LPR may have the lower power consumption than the HPR at the UE 502. Moreover, 1108 may be performed by the component 199 in FIG. 13 or 14.

At 1110, the UE may simultaneously communicate a second signal with the first radio and communicate a third signal with the second radio during a first time period. For example, 1110 may be performed by the UE 502 in FIG. 5, which may simultaneously communicate the one or more transmissions 514 with the HPR at the UE 502 and communicate the one or more transmissions 516 with the LPR at the UE 502 during a time period. 1110 may also be performed by the UE 502 in FIG. 5, which may simultaneously communicate the one or more transmissions 524 with the HPR at the UE 502 and communicate the one or more transmissions 526 with the LPR at the UE 502 during a time period. Moreover, 1110 may be performed by the component 198 in FIG. 12.

At 1112, the UE may communicate the second signal using a first set of resources and communicate the third signal using a second set of resources during the first time period. The first set of resources may be non-overlapping with and non-adjacent with the second set of resources. For example, 1112 may be performed by the UE 502 in FIG. 5, which may communicate the one or more transmissions 514 using a first set of resources and communicate the one or more transmissions 516 using a second set of resources during the time period. 1112 may also be performed by the UE 502 in FIG. 5, which may communicate the one or more transmissions 524 using a first set of resources and communicate the one or more transmissions 526 using a second set of resources during the time period. The first set of resources may be non-overlapping with and non-adjacent with the second set of resources. Moreover, 1112 may be performed by the component 198 in FIG. 12.

At 1114, the UE may multiplex the second signal and the third signal via TDM to communicate the second signal during a first set of time periods and communicate the third signal during a second set of time periods. The first time period may include the first set of time periods and the second set of time periods. For example, 1114 may be performed by the UE 502 in FIG. 5, which may multiplex the one or more transmissions 514 and the one or more transmissions 516 via TDM to communicate the one or more transmissions 514 during a first set of time periods with the HPR of the UE 502 and communicate the one or more transmissions 516 during a second set of time periods with the LPR of the UE 502. The time period that the UE 502 uses to communicate the one or more transmissions 514 and the one or more transmissions 516 may include the first set of time periods and the second set of time periods. 1114 may also be performed by the UE 502 in FIG. 5, which may multiplex the one or more transmissions 524 and the one or more transmissions 526 via TDM to communicate the one or more transmissions 524 during a first set of time periods with the HPR of the UE 502 and communicate the one or more transmissions 526 during a second set of time periods with the LPR of the UE 502. The time period that the UE 502 uses to communicate the one or more transmissions 524 and the one or more transmissions 526 may include the first set of time periods and the second set of time periods. Moreover, 1114 may be performed by the component 198 in FIG. 12.

FIG. 12 is a diagram 1200 illustrating an example of a hardware implementation for an apparatus 1204. The apparatus 1204 may be a UE, a component of a UE, or may implement UE functionality. In some aspects, the apparatus 1004 may include a cellular baseband processor 1224 (also referred to as a modem) coupled to one or more transceivers 1222 (e.g., cellular RF transceiver). The cellular baseband processor 1224 may include on-chip memory 1224′. In some aspects, the apparatus 1204 may further include one or more subscriber identity modules (SIM) cards 1220 and an application processor 1206 coupled to a secure digital (SD) card 1208 and a screen 1210. The application processor 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver). The Bluetooth module 1212, the WLAN module 1214, and the SPS module 1216 may include their own dedicated antennas and/or utilize the antennas 1280 for communication. The cellular baseband processor 1224 communicates through the transceiver(s) 1222 via one or more antennas 1280 with the UE 104 and/or with an RU associated with a network entity 1202. The cellular baseband processor 1224 and the application processor 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor 1224 and the application processor 1206 are each responsible for general processing, including the execution of software stored on the computer-readable medium/memory. The software, when executed by the cellular baseband processor 1224/application processor 1206, causes the cellular baseband processor 1224/application processor 1206 to perform the various functions described supra. The computer-readable medium/memory may also be used for storing data that is manipulated by the cellular baseband processor 1224/application processor 1206 when executing software. The cellular baseband processor 1224/application processor 1206 may be a component of the UE 350 and may include the memory 360 and/or at least one of the Tx processor 368, the Rx processor 356, and the controller/processor 359. In one configuration, the apparatus 1204 may be a processor chip (modem and/or application) and include just the cellular baseband processor 1224 and/or the application processor 1206, and in another configuration, the apparatus 1204 may be the entire UE (e.g., see UE 350 in FIG. 3) and include the additional modules of the apparatus 1204.

As discussed supra, the component 198 may be configured to receive a first signal including a first configuration using a first radio at the UE. The component 198 may be configured to operate a second radio at the UE in a first mode based on the first configuration received via the first radio. The first radio may have a lower power consumption than the second radio or the second radio may have the lower power consumption than the first radio. The component 198 may be within the cellular baseband processor 1224, the application processor 1206, or both the cellular baseband processor 1224 and the application processor 1206. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1204 may include a variety of components configured for various functions. In one configuration, the apparatus 1204, and in particular the cellular baseband processor 1224 and/or the application processor 1206, may include means for receiving a first signal including a first configuration using a first radio at the UE. The apparatus 1204 may include means for operating a second radio at the UE in a first mode based on the first configuration received via the first radio. The apparatus 1204 may include means for configuring the first radio based on a second configuration. The apparatus 1204 may include means for operating the first radio at the UE in a second mode based on the second configuration received via the first radio. The apparatus 1204 may include means for operating the first radio at the UE in the second mode and operating the second radio at the UE in the first mode by simultaneously communicating a second signal at the first radio and communicating a third signal at the second radio during a first time period. The apparatus 1204 may include means for simultaneously communicating the second signal at the first radio and communicating the third signal at the second radio by communicating the second signal using a first set of resources and communicating the third signal using a second set of resources during the first time period. The apparatus 1204 may include means for simultaneously communicating the second signal at the first radio and communicating the third signal at the second radio by multiplexing the second signal and the third signal via TDM to communicate the second signal during a first set of time periods and communicate the third signal during a second set of time periods. The apparatus 1204 may include means for transmitting a UE capability to a network node. The apparatus 1204 may include means for operating the first radio at the UE in the second mode by communicating a second signal at the first radio using a Uu connection. The apparatus 1204 may include means for operating the second radio at the UE in the first mode by communicating a third signal at the second radio using a sidelink connection. The apparatus 1204 may include means for transmitting a UE capability to a network node. The apparatus 1204 may include means for operating the second radio at the UE in the first mode by communicating a second signal at the second radio. The apparatus 1204 may include means for deactivating at least one of an SW component, a FW component, a HW component, or an RF component associated with DL. The apparatus 1204 may include means for deactivating at least one of an SW component, a FW component, a HW component, or an RF component associated with UL. The apparatus 1204 may include means for skipping monitoring a PDCCH. The apparatus 1204 may include means for transmitting the second signal using a CG resource. The apparatus 1204 may include means for calculating a wakeup time based on a QoS requirement associated with the service information. The apparatus 1204 may include means for selecting at least one a QCL source, a TCI state, a tracking loop state, an AGC, or a reference signal associated with the connection type. The apparatus 1204 may include means for operating the first radio at the UE in the second mode by communicating in an RRC connected mode via the first radio. The apparatus 1204 may include means for operating the second radio at the UE in the first mode by transmitting HARQ feedback via the second radio for data received on the first radio. The apparatus 1204 may include means for operating the first radio at the UE in the second mode by transmitting HARQ feedback via the second radio for data received on the first radio. The apparatus 1204 may include means for operating the second radio at the UE in the first mode by transmitting CSI via the second radio for a channel associated with the first radio. The apparatus 1204 may include means for operating the second radio at the UE in the first mode by receiving downlink or uplink scheduling information via the second radio for transmission or reception on the first radio. The apparatus 1204 may include means for applying one or more collision rules for a first collision at the first radio prior to applying the one or more collision rules for a second collision at the second radio. The apparatus 1204 may include means for transmitting a colliding transmission via the second radio if the one or more collision rules for the first collision at the first radio indicate for the colliding transmission to be dropped. The apparatus 1204 may include means for Operating the first radio at the UE in the second mode by receiving a second signal via the first radio. The apparatus 1204 may include means for operating the second radio at the UE in the first mode by transmitting a NACK associated with the second signal via the second radio. The apparatus 1204 may include means for receiving a retransmission of the second signal via the second radio. The apparatus 1204 may include means for receiving the retransmission of the second signal via the second radio by receiving the retransmission of the second signal in at least one of (a) a first set of TBs larger than a second set of TBs associated with the second signal received via the first radio or (b) a first period of time larger than a second period of time associated with the second signal received via the first radio. The apparatus 1204 may include means for decoding the retransmission of the second signal while the first radio is in a sleep mode. The apparatus 1204 may include means for storing the decoded retransmission of the second signal in a memory associated with the second radio and the first radio. The apparatus 1204 may include means for receiving LP-WUS to switch the first radio to a wake-up mode via the second radio. The apparatus 1204 may include means for decoding the retransmission of the second signal in response to receiving the LP-WUS. The apparatus 1204 may include means for storing the retransmission of the second signal in a memory associated with the second radio. The apparatus 1204 may include means for decoding the retransmission of the second signal by retrieving the retransmission of the second signal from the memory associated with the second radio. The apparatus 1204 may include means for operating the first radio at the UE in the second mode by receiving a second signal via the second radio. The apparatus 1204 may include means for operating the second radio at the UE in the first mode by receiving a third signal via the first radio. The apparatus 1204 may include means for multiplexing a first response to the second signal with a second response to the third signal to generate a multiplexed response. The apparatus 1204 may include means for transmitting the multiplexed response via one of the first radio or the second radio. The apparatus 1204 may include means for operating the second radio at the UE in the first mode by at least one of (a) transmitting a schedule request, (b) transmitting a HARQ-ACK associated with a second signal received by the first radio or a third signal received by the second radio, (c) transmitting a CSI associated with a fourth signal received by the first radio, or (d) receiving a scheduling grant for communication associated with the first radio. The apparatus 1204 may include means for operating the second radio at the UE in the first mode by receiving an RS that includes a first clock configuration via the second radio. The apparatus 1204 may include means for configuring a first clock associated with the first radio based on the first clock configuration. The apparatus 1204 may include means for configuring the first clock associated with the first radio based on the first clock configuration by at least one of (a) tracking a configuration time associated with the first clock configuration, (b) tracking a configuration frequency associated with the first clock configuration, (c) synchronizing a time associated with the first clock based on the configuration time associated with the first clock configuration, (d) synchronizing a frequency associated with the first clock based on the configuration frequency associated with the first clock configuration, (e) correcting the time associated with the first clock based on a time estimation error calculated based on the first clock configuration, (f) correcting the frequency associated with the first clock based on a frequency estimation error calculated based on the first clock configuration, or (g) estimating a channel at the first radio based on the first clock configuration. The apparatus 1204 may include means for transmitting a second signal including at least one parameter associated with the first clock via the second radio. The apparatus 1204 may include means for configuring a second clock associated with the first radio based on a second clock configuration. The apparatus 1204 may include means for receiving a second RS including a second clock configuration via the second radio. The apparatus 1204 may include means for configuring a second clock associated with the first radio based on the second clock configuration. The apparatus 1204 may include means for transmitting a UE capability including a first indicator of at least one of a RedCap connection, an eRedCap connection, or a non-RedCap connection. The means may be the component 198 of the apparatus 1204 configured to perform the functions recited by the means. As described supra, the apparatus 1204 may include the Tx processor 368, the Rx processor 356, and the controller/processor 359. As such, in one configuration, the means may be the Tx processor 368, the Rx processor 356, and/or the controller/processor 359 configured to perform the functions recited by the means.

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. For example, depending on the layer functionality handled by the component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include a CU processor 1312. The CU processor 1312 may include on-chip memory 1312′. In some aspects, the CU 1310 may further include additional memory modules 1314 and a communications interface 1318. The CU 1310 communicates with the DU 1330 through a midhaul link, such as an F1 interface. The DU 1330 may include a DU processor 1332. The DU processor 1332 may include on-chip memory 1332′. In some aspects, the DU 1330 may further include additional memory modules 1334 and a communications interface 1338. The DU 1330 communicates with the RU 1340 through a fronthaul link. The RU 1340 may include an RU processor 1342. The RU processor 1342 may include on-chip memory 1342′. In some aspects, the RU 1340 may further include additional memory modules 1344, one or more transceivers 1346, antennas 1380, and a communications interface 1348. The RU 1340 communicates with the UE 104. The on-chip memory 1312′, 1332′, 1342′ and the additional memory modules 1314, 1334, 1344 may each be considered a computer-readable medium/memory. Each computer-readable medium/memory may be non-transitory. Each of the processors 1312, 1332, 1342 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to transmit a first signal including a first configuration for a second radio to a first radio at a UE. The component 199 may be configured to communicate with the second radio at the UE based on the first configuration transmitted to the first radio. The first radio may have a lower power consumption than the second radio or the second radio has the lower power consumption than the first radio. The component 199 may be within one or more processors of one or more of the CU 1310, DU 1330, and the RU 1340. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1302 may include a variety of components configured for various functions. In one configuration, the network entity 1302 may include means for transmitting a first signal including a first configuration for a second radio to a first radio at a UE. The network entity 1302 may include means for communicating with the second radio at the UE based on the first configuration transmitted to the first radio. The network entity 1302 may include means for communicating with the first radio at the UE based on the second configuration transmitted to the first radio. The network entity 1302 may include means for communicating with the first radio at the UE and communicating with the second radio at the UE by simultaneously communicating a second signal with the first radio and communicating a third signal with the second radio during a first time period. The network entity 1302 may include means for simultaneously communicating the second signal at the first radio and communicating the third signal at the second radio by at least one of (a) communicating the second signal using a first set of resources and communicating the third signal using a second set of resources during the first time period, where the first set of resources may be non-overlapping with and non-adjacent with the second set of resources, or (b) multiplexing the second signal and the third signal via TDM to communicate the second signal during a first set of time periods and communicate the third signal during a second set of time periods, where the first time period may include the first set of time periods and the second set of time periods. The network entity 1302 may include means for receiving a UE capability from the UE. The network entity 1302 may include means for communicating with the first radio at the UE by communicating a second signal with the first radio at the UE using a Uu connection. The network entity 1302 may include means for communicating with the second radio at the UE by communicating a third signal with the second radio at the UE using a sidelink connection. The network entity 1302 may include means for receiving a UE capability from the UE. The network entity 1302 may include means for communicating with the second radio at the UE by communicating a second signal with the second radio at the UE. The network entity 1302 may include means for communicating with the first radio at the UE by communicating with the first radio in an RRC connected mode. The network entity 1302 may include means for communicating with the second radio at the UE by at least one of (a) receiving a scheduling request from the second radio at the UE, (b) receiving HARQ feedback from the second radio at the UE for data received by the first radio at the UE, (c) receiving CSI from the second radio at the UE for a channel associated with the first radio at the UE, or (d) transmitting downlink or uplink scheduling information from the second radio at the UE for transmission or reception on the first radio. The network entity 1302 may include means for receiving a colliding transmission from the second radio at the UE if one or more collision rules for a first collision at the first radio indicates for the colliding transmission to be dropped. The network entity 1302 may include means for communicating with the first radio at the UE by transmitting a second signal to the first radio at the UE. The network entity 1302 may include means for communicating with the second radio at the UE by receiving a NACK associated with the second signal from the second radio at the UE. The network entity 1302 may include means for transmitting a retransmission of the second signal to the second radio at the UE based on receiving the NACK associated with the second signal. The network entity 1302 may include means for transmitting the retransmission of the second signal to the second radio by transmitting the retransmission of the second signal in at least one of a first set of TBs larger than a second set of TBs associated with the second signal transmitted to the first radio or in a first period of time larger than a second period of time associated with the second signal transmitted to the first radio. The network entity 1302 may include means for communicating with the first radio at the UE by transmitting a second signal to the second radio at the UE. The network entity 1302 may include means for communicating with the second radio at the UE by transmitting a third signal to the first radio at the UE. The network entity 1302 may include means for receiving a multiplexed response from one of the first radio or the second radio. The network entity 1302 may include means for communicating with the second radio at the UE by at least one of (a) receiving a schedule request, (b) receiving a HARQ-ACK associated with a second signal transmitted to the first radio or a third signal transmitted to the second radio, (c) receiving a (CSI feedback signal associated with a fourth signal transmitted to the first radio, or (d) transmitting a scheduling grant for communication associated with the first radio. The network entity 1302 may include means for communicating with the second radio at the UE by transmitting an RS including a first clock configuration for a first clock associated with the first radio to the second radio at the UE. The network entity 1302 may include means for receiving a second signal including at least one parameter associated with the first clock from the second radio at the UE. The network entity 1302 may include means for transmitting a second RS including a second clock configuration for a second clock via the second radio. The network entity 1302 may include means for receiving a UE capability including a first indicator of at least one of a RedCap connection, an eRedCap connection, or a non-RedCap connection. The network entity 1302 may include means for communicating with the first radio at the UE based on the second configuration transmitted to the first radio by transmitting a set of cell IDs to the first radio. The network entity 1302 may include means for transmitting the set of cell IDs to the first radio by transmitting at least one of a PSS or an SSS to the first radio including the set of cell IDs. The means may be the component 199 of the network entity 1302 configured to perform the functions recited by the means. As described supra, the network entity 1302 may include the Tx processor 316, the Rx processor 370, and the controller/processor 375. As such, in one configuration, the means may be the Tx processor 316, the Rx processor 370, and/or the controller/processor 375 configured to perform the functions recited by the means.

FIG. 14 is a diagram 1400 illustrating an example of a hardware implementation for a network entity 1460. In one example, the network entity 1460 may be within the core network 140. The network entity 1460 may include a network processor 1412. The network processor 1412 may include on-chip memory 1412′. In some aspects, the network entity 1460 may further include additional memory modules 1414. The network entity 1460 communicates via the network interface 1480 directly (e.g., backhaul link) or indirectly (e.g., through a RIC) with the CU 1402. The on-chip memory 1412′ and the additional memory modules 1414 may each be considered a computer-readable medium/memory. Each computer-readable medium/memory may be non-transitory. The processor 1412 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to transmit a first signal including a first configuration for a second radio to a first radio at a UE. The component 199 may be configured to communicate with the second radio at the UE based on the first configuration transmitted to the first radio. The first radio may have a lower power consumption than the second radio or the second radio has the lower power consumption than the first radio. The component 199 may be within the processor 1412. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1460 may include a variety of components configured for various functions. In one configuration, the network entity 1460 may include means for transmitting a first signal including a first configuration for a second radio to a first radio at a UE. The network entity 1460 may include means for communicating with the second radio at the UE based on the first configuration transmitted to the first radio. The network entity 1460 may include means for communicating with the first radio at the UE based on the second configuration transmitted to the first radio. The network entity 1460 may include means for communicating with the first radio at the UE and communicating with the second radio at the UE by simultaneously communicating a second signal with the first radio and communicating a third signal with the second radio during a first time period. The network entity 1460 may include means for simultaneously communicating the second signal at the first radio and communicating the third signal at the second radio by at least one of (a) communicating the second signal using a first set of resources and communicating the third signal using a second set of resources during the first time period, where the first set of resources may be non-overlapping with and non-adjacent with the second set of resources, or (b) multiplexing the second signal and the third signal via TDM to communicate the second signal during a first set of time periods and communicate the third signal during a second set of time periods, where the first time period may include the first set of time periods and the second set of time periods. The network entity 1460 may include means for receiving a UE capability from the UE. The network entity 1460 may include means for communicating with the first radio at the UE by communicating a second signal with the first radio at the UE using a Uu connection. The network entity 1460 may include means for communicating with the second radio at the UE by communicating a third signal with the second radio at the UE using a sidelink connection. The network entity 1460 may include means for receiving a UE capability from the UE. The network entity 1460 may include means for communicating with the second radio at the UE by communicating a second signal with the second radio at the UE. The network entity 1460 may include means for communicating with the first radio at the UE by communicating with the first radio in an RRC connected mode. The network entity 1460 may include means for communicating with the second radio at the UE by at least one of (a) receiving a scheduling request from the second radio at the UE, (b) receiving HARQ feedback from the second radio at the UE for data received by the first radio at the UE, (c) receiving CSI from the second radio at the UE for a channel associated with the first radio at the UE, or (d) transmitting downlink or uplink scheduling information from the second radio at the UE for transmission or reception on the first radio. The network entity 1460 may include means for receiving a colliding transmission from the second radio at the UE if one or more collision rules for a first collision at the first radio indicates for the colliding transmission to be dropped. The network entity 1460 may include means for communicating with the first radio at the UE by transmitting a second signal to the first radio at the UE. The network entity 1460 may include means for communicating with the second radio at the UE by receiving a NACK associated with the second signal from the second radio at the UE. The network entity 1460 may include means for transmitting a retransmission of the second signal to the second radio at the UE based on receiving the NACK associated with the second signal. The network entity 1460 may include means for transmitting the retransmission of the second signal to the second radio by transmitting the retransmission of the second signal in at least one of a first set of TBs larger than a second set of TBs associated with the second signal transmitted to the first radio or in a first period of time larger than a second period of time associated with the second signal transmitted to the first radio. The network entity 1460 may include means for communicating with the first radio at the UE by transmitting a second signal to the second radio at the UE. The network entity 1460 may include means for communicating with the second radio at the UE by transmitting a third signal to the first radio at the UE. The network entity 1460 may include means for receiving a multiplexed response from one of the first radio or the second radio. The network entity 1460 may include means for communicating with the second radio at the UE by at least one of (a) receiving a schedule request, (b) receiving a HARQ-ACK associated with a second signal transmitted to the first radio or a third signal transmitted to the second radio, (c) receiving a (CSI feedback signal associated with a fourth signal transmitted to the first radio, or (d) transmitting a scheduling grant for communication associated with the first radio. The network entity 1460 may include means for communicating with the second radio at the UE by transmitting an RS including a first clock configuration for a first clock associated with the first radio to the second radio at the UE. The network entity 1460 may include means for receiving a second signal including at least one parameter associated with the first clock from the second radio at the UE. The network entity 1460 may include means for transmitting a second RS including a second clock configuration for a second clock via the second radio. The network entity 1460 may include means for receiving a UE capability including a first indicator of at least one of a RedCap connection, an eRedCap connection, or a non-RedCap connection. The network entity 1460 may include means for communicating with the first radio at the UE based on the second configuration transmitted to the first radio by transmitting a set of cell IDs to the first radio. The network entity 1460 may include means for transmitting the set of cell IDs to the first radio by transmitting at least one of a PSS or an SSS to the first radio including the set of cell IDs. The means may be the component 199 of the network entity 1460 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data.

The following aspects are illustrative only and may be combined with other aspects or teachings described herein, without limitation.

Aspect 1 is a method of wireless communication at a UE, where the method may include receiving a first signal including a first configuration using a first radio at the UE. The method may include operating a second radio at the UE in a first mode based on the first configuration received via the first radio. The first radio may have a lower power consumption than the second radio or the second radio may have the lower power consumption than the first radio.

Aspect 2 is the method of aspect 1, where the first radio may include an MR. The second radio may include an LP-WUR, a passive IoT device, a backscatter-based radio, or an RFID tag radio.

Aspect 3 is the method of any of aspects 1 and 2, where the method may include configuring the first radio based on a second configuration. The first signal may include the second configuration. The method may include operating the first radio at the UE in a second mode based on the second configuration received via the first radio.

Aspect 4 is the method of aspect 3, where operating the first radio at the UE in the second mode and operating the second radio at the UE in the first mode may include simultaneously communicating a second signal at the first radio and communicating a third signal at the second radio during a first time period.

Aspect 5 is the method of any aspect 4, where simultaneously communicating the second signal at the first radio and communicating the third signal at the second radio may include at least one of (a) communicating the second signal using a first set of resources and communicating the third signal using a second set of resources during the first time period, where the first set of resources may be non-overlapping with and non-adjacent with the second set of resources, or (b) multiplexing the second signal and the third signal via TDM to communicate the second signal during a first set of time periods and communicate the third signal during a second set of time periods, where the first time period may include both the first set of time periods and the second set of time periods.

Aspect 6 is the method of either of aspects 4 or 5, where the method may include transmitting a UE capability to a network node. The UE capability may include an indicator of a simultaneous connectivity capability that indicates at least one of an identifier of the UE, a common set of bands, or a common set of CCs.

Aspect 7 is the method of any of aspects 4 to 6, where the first signal may include at least one of an LP-WUS, an LP-RS or an LP-SS. The first configuration may include at least one of (a) a minimum time threshold for the UE to switch between operating the first radio at the UE in the second mode and operating the second radio at the UE in the first mode, (b) a first PDCCH occasion indicator associated with the first radio and a second PDCCH occasion indicator associated with the second radio, (c) a first slot format associated with the first radio and a second slot format associated with the second radio, or (d) a first signal type associated with the first radio and a second signal type associated with the second radio.

Aspect 8 is the method of aspect 7, where the first signal type may include at least one of a PMO, an SPS occasion, a CG occasion, an SRS occasion, or a CSI-RS occasion.

Aspect 9 is the method of aspect 3, where operating the first radio at the UE in the second mode may include communicating a second signal at the first radio using a Uu connection. Operating the second radio at the UE in the first mode may include communicating a third signal at the second radio using a sidelink connection.

Aspect 10 is the method of aspect 3, where the method may include transmitting a UE capability to a network node. The UE capability may include an indicator of a transition time between operating the first radio and operating the second radio. A schedule associated with the first configuration and the second configuration may be based on the indicator.

Aspect 11 is the method of aspect 3, where the first signal may be received via the first radio or the second radio having the lower power consumption. The first signal may indicate a sleep mode for at least one of the first radio or the second radio. The first configuration may indicate a sleep mode configuration associated with at least one of (a) a first transmitter of the first radio associated with a first Uu connection, (b) a second transmitter of the first radio associated with a first sidelink connection, (c) a third transmitter of the first radio associated with the first Uu connection and the first sidelink connection, (d) a first receiver of the first radio associated with the first Uu connection, (e) a second receiver of the first radio associated with the first sidelink connection, (f) a third receiver of the first radio associated with the first Uu connection and the first sidelink connection, (g) a fourth transmitter of the second radio associated with a second Uu connection, (h) a fifth transmitter of the second radio associated with a second sidelink connection, (i) a sixth transmitter of the second radio associated with the second Uu connection and the second sidelink connection, (j) a fourth receiver of the second radio associated with the second Uu connection, (k) a fifth receiver of the second radio associated with the second sidelink connection, or (l) a sixth receiver of the second radio associated with the second Uu connection and the second sidelink connection.

Aspect 12 is the method of aspect 3, where the first signal may include an LP-WUS. The first configuration may indicate a wake-up mode configuration associated with at least one of (a) a first transmitter of the first radio associated with a first Uu connection, (b) a second transmitter of the first radio associated with a first sidelink connection, (c) a third transmitter of the first radio associated with the first Uu connection and the first sidelink connection, (d) a first receiver of the first radio associated with the first Uu connection, (e) a second receiver of the first radio associated with the first sidelink connection, (f) a third receiver of the first radio associated with the first Uu connection and the first sidelink connection, (g) a fourth transmitter of the second radio associated with a second Uu connection, (h) a fifth transmitter of the second radio associated with a second sidelink connection, (i) a sixth transmitter of the second radio associated with the second Uu connection and the second sidelink connection, (j) a fourth receiver of the second radio associated with the second Uu connection, (k) a fifth receiver of the second radio associated with the second sidelink connection, or (l) a sixth receiver of the second radio associated with the second Uu connection and the second sidelink connection.

Aspect 13 is the method of aspect 3, where the first signal may include at least one of an LP-WUS, an LP-sync-preamble signal, an LP-RS, or an LP-SS. Operating the second radio at the UE in the first mode may include communicating a second signal at the second radio. The first configuration may include at least one of (a) a cast type associated with communicating the second signal at the second radio, (b) a communication mode associated with communicating the second signal at the second radio, (c) a duplex mode associated with communicating the second signal at the second radio, (d) a service information associated with communicating the second signal at the second radio, (e) a device type associated with the UE, (f) a connection type associated with communicating the second signal at the second radio, (g) a CLI measurement associated with communicating the second signal at the second radio, or (h) a non-data service parameter associated with communicating the second signal at the second radio.

Aspect 14 is the method of aspect 13, where the cast type may include at least one of a unicast type, a broadcast type, or a multi-cast type.

Aspect 15 is the method of either of aspects 13 or 14, where the wake-up mode configuration may include an instruction for at least one of (a) receiving a PDCCH scheduling the second signal, (b) selecting a QCL source and a TCI state for data communication associated with the cast type, (c) receiving a CSI-RS associated with the cast type, (d) transmitting the second signal using a CG resource, or (e) receiving the second signal using an SPS resource.

Aspect 16 is the method of any of aspects 13 to 15, where the communication mode may include at least one of a transmission mode, a reception mode, or a transmission and reception mode.

Aspect 17 is the method of aspect 16, where the transmission mode may include a UL mode associated with at least one of a Uu connection or a sidelink connection.

Aspect 18 is the method of either of aspects 16 or 17, where the reception mode may include a DL mode associated with at least one of a Uu connection or a sidelink connection.

Aspect 19 is the method of any of aspects 16 to 18, where the communication mode may include an UL only mode. The method may include deactivating at least one of an SW component, a FW component, a HW component, or an RF component associated with DL.

Aspect 20 is the method of any of aspects 16 to 18 where the communication mode may include a DL only mode. The method may include deactivating at least one of an SW component, a FW component, a HW component, or an RF component associated with UL.

Aspect 21 is the method of any of aspects 16 to 19, where the communication mode may include an UL only mode. The method may include skipping monitoring a PDCCH. The method may include transmitting the second signal using a CG resource.

Aspect 22 is the method of any of aspects 13 to 21, where the duplex mode may include at least one of a half-duplex mode or a full-duplex mode.

Aspect 23 is the method of aspect 22, where the method may include selecting a QCL source and a TCI state for data communication associated with the duplex mode. The method may include selecting a slot format associated with the duplex mode.

Aspect 24 is the method of any of aspects 13 to 23, where the service information may include at least one of eMBB service information, URLLC service information, or XR service information.

Aspect 25 is the method of aspect 24, where the method may include calculating a wakeup time based on a QoS requirement associated with the service information.

Aspect 26 is the method of aspect 25, where the QoS requirement may include at least one of a latency requirement, a bandwidth requirement, or a number of CCs requirement.

Aspect 27 is the method of any of aspects 13 to 26, where the device type may include at least one of a smart phone device type or a RedCap device type.

Aspect 28 is the method of any of aspects 13 to 27, where the non-data service parameter may include at least one of a sensing parameter or a positioning parameter.

Aspect 29 is the method of any of aspects 13 to 28, where the connection type may include at least one of a Uu connection type or a sidelink connection type.

Aspect 30 is the method of aspect 29, where the method may include selecting at least one a QCL source, a TCI state, a tracking loop state, an AGC, or a reference signal associated with the connection type.

Aspect 31 is the method of aspect 3, where the second radio may have the lower power consumption than the first radio. Operating the first radio at the UE in the second mode may include communicating in an RRC connected mode via the first radio. Operating the second radio at the UE in the first mode may include at least one of (a) transmitting a scheduling request via the second radio, (b) transmitting HARQ feedback via the second radio for data received on the first radio, (c) transmitting CSI via the second radio for a channel associated with the first radio, or (d) receiving downlink or uplink scheduling information via the second radio for transmission or reception on the first radio.

Aspect 32 is the method of aspect 3, where the second radio may have the lower power consumption than the first radio. The method may include applying one or more collision rules for a first collision at the first radio prior to applying the one or more collision rules for a second collision at the second radio. The method may include transmitting a colliding transmission via the second radio if the one or more collision rules for the first collision at the first radio indicate for the colliding transmission to be dropped.

Aspect 33 is the method of aspect 3, where the second radio may have the lower power consumption than the first radio. Operating the first radio at the UE in the second mode may include receiving a second signal via the first radio. Operating the second radio at the UE in the first mode may include transmitting a NACK associated with the second signal via the second radio.

Aspect 34 is the method of aspect 33, where the method may include receiving a retransmission of the second signal via the second radio.

Aspect 35 is the method of aspect 34, where receiving the retransmission of the second signal via the second radio may include receiving the retransmission of the second signal in at least one of (a) a first set of TB s larger than a second set of TB s associated with the second signal received via the first radio or (b) a first period of time larger than a second period of time associated with the second signal received via the first radio.

Aspect 36 is the method of either aspect 34 or 35, where the method may include decoding the retransmission of the second signal while the first radio is in a sleep mode.

Aspect 37 is the method of aspect 36, where the method may include storing the decoded retransmission of the second signal in a memory associated with the second radio and the first radio.

Aspect 38 is the method of aspect 34, where the method may include receiving LP-WUS to switch the first radio to a wake-up mode via the second radio. The method may include decoding the retransmission of the second signal in response to receiving the LP-WUS.

Aspect 39 is the method of aspect 38, where the method may include storing the retransmission of the second signal in a memory associated with the second radio. Decoding the retransmission of the second signal may include retrieving the retransmission of the second signal from the memory associated with the second radio.

Aspect 40 is the method of aspect 3, where operating the first radio at the UE in the second mode may include receiving a second signal via the second radio. Operating the second radio at the UE in the first mode may include receiving a third signal via the first radio. The method may include multiplexing a first response to the second signal with a second response to the third signal to generate a multiplexed response. The method may include transmitting the multiplexed response via one of the first radio or the second radio.

Aspect 41 is the method of aspect 40, where the first response may include at least one of a HARQ-ACK or a CSI.

Aspect 42 is the method of any of aspects 1 to 41, where the second radio may have the lower power consumption than the first radio. Operating the second radio at the UE in the first mode may include at least one of (a) transmitting a schedule request, (b) transmitting a HARQ-ACK associated with a second signal received by the first radio or a third signal received by the second radio, (c) transmitting a CSI associated with a fourth signal received by the first radio, or (d) receiving a scheduling grant for communication associated with the first radio.

Aspect 43 is the method of any of aspects 1 to 42, where the first radio may have the lower power consumption than the second radio. Operating the second radio at the UE in the first mode may include receiving an RS that includes a first clock configuration via the second radio. The method may include configuring a first clock associated with the first radio based on the first clock configuration.

Aspect 44 is the method of aspect 43, where configuring the first clock associated with the first radio based on the first clock configuration may include at least one of (a) tracking a configuration time associated with the first clock configuration, (b) tracking a configuration frequency associated with the first clock configuration, (c) synchronizing a time associated with the first clock based on the configuration time associated with the first clock configuration, (d) synchronizing a frequency associated with the first clock based on the configuration frequency associated with the first clock configuration, (e) correcting the time associated with the first clock based on a time estimation error calculated based on the first clock configuration, (f) correcting the frequency associated with the first clock based on a frequency estimation error calculated based on the first clock configuration, or (g) estimating a channel at the first radio based on the first clock configuration.

Aspect 45 is the method of either of aspects 43 to 44, where the RS may include at least one of DCI, a MAC-CE, or an RRC configuration.

Aspect 46 is the method of any of aspects 43 to 45, where the method may include transmitting a second signal including at least one parameter associated with the first clock via the second radio. The first clock configuration may be based on the at least one parameter.

Aspect 47 is the method of aspect 46, where the second signal may be at least one of an initial access message or a capability information message.

Aspect 48 is the method of either of aspects 46 or 47, where the at least one parameter associated with the first clock may include at least one of a clock type (e.g., RTC, LO XO), a frequency drift, a frequency drift range, a maximum frequency error, a maximum frequency error range, or a clock schedule.

Aspect 49 is the method of aspects 46 to 48, where the at least one parameter associated with the first clock may include a value, a range of values, a set of values, a mean parameter statistic, or a variance parameter statistic.

Aspect 50 is the method of either of aspects 48 or 49, where the at least one parameter may be associated with at least one of a clock type, an RRC state, a power mode at the UE, or predicted traffic characteristics.

Aspect 51 is the method of any of aspects 43 to 50, where the method may include configuring a second clock associated with the first radio based on a second clock configuration. The RS may include the second clock configuration. The second clock may have at least a different accuracy or a different clock parameter than the first clock.

Aspect 52 is the method of any of aspects 43 to 51, where the method may include receiving a second RS including a second clock configuration via the second radio. The method may include configuring a second clock associated with the first radio based on the second clock configuration. The second clock may have at least a different accuracy or a different clock parameter than the first clock.

Aspect 53 is the method of any of aspects 1 to 52, where the method may include transmitting a UE capability including a first indicator of at least one of a RedCap connection, an eRedCap connection, or a non-RedCap connection. The first signal may include at least one of an LP-WUS, an LP-sync preamble signal, an LP-RS or an LP-SS including a second indicator to operate the second radio at the UE in the first mode. The first mode may be associated with the first indicator.

Aspect 54 is a method of wireless communication at a network node, where the method may include transmitting a first signal including a first configuration for a second radio to a first radio at a UE. The method may include communicating with the second radio at the UE based on the first configuration transmitted to the first radio. The first radio may have a lower power consumption than the second radio or the second radio has the lower power consumption than the first radio.

Aspect 55 is the method of aspect 54, where the first radio may include a MR and the second radio may include an LP-WUR.

Aspect 56 is the method of either of aspects 54 or 55, where the first signal may include a second configuration for the first radio. The method may include communicating with the first radio at the UE based on the second configuration transmitted to the first radio.

Aspect 57 is the method of aspect 56, where communicating with the first radio at the UE and communicating with the second radio at the UE may include simultaneously communicating a second signal with the first radio and communicating a third signal with the second radio during a first time period.

Aspect 58 is the method of aspect 57, where simultaneously communicating the second signal at the first radio and communicating the third signal at the second radio may include at least one of (a) communicating the second signal using a first set of resources and communicating the third signal using a second set of resources during the first time period, where the first set of resources may be non-overlapping with and non-adjacent with the second set of resources, or (b) multiplexing the second signal and the third signal via TDM to communicate the second signal during a first set of time periods and communicate the third signal during a second set of time periods, where the first time period may include the first set of time periods and the second set of time periods.

Aspect 59 is the method of either of aspects 57 or 58, where the method may include receiving a UE capability from the UE. The UE capability may include an indicator of a simultaneous connectivity capability that indicates at least one of an identifier of the UE, a common set of bands, or a common set of CCs.

Aspect 60 is the method of any of aspects 57 to 59, where the first signal may include at least one of an LP-WUS, an LP-RS, or an LP-SS. The first configuration may include at least one of (a) a minimum time threshold for the UE to switch between operating the first radio at the UE and operating the second radio at the UE, (b) a first PDCCH occasion indicator associated with the first radio and a second PDCCH occasion indicator associated with the second radio, (c) a first slot format associated with the first radio and a second slot format associated with the second radio, or (d) a first signal type associated with the first radio and a second signal type associated with the second radio.

Aspect 61 is the method of aspect 60, where the first signal type may include at least one of a PMO, an SPS occasion, a CG occasion, an SRS occasion, or a CSI-RS occasion.

Aspect 62 is the method of aspect 56, where communicating with the first radio at the UE may include communicating a second signal with the first radio at the UE using a Uu connection. Communicating with the second radio at the UE may include communicating a third signal with the second radio at the UE using a sidelink connection.

Aspect 63 is the method of any of aspects 56 to 62, where the method may include receiving a UE capability from the UE. The UE capability may include an indicator of a transition time between a first operation of the first radio and a second operation of the second radio. A schedule associated with the first configuration and the second configuration may be based on the indicator.

Aspect 64 is the method of aspect 56, where the first signal may be transmitted to the first radio or the second radio having the lower power consumption. The first signal may indicate a sleep mode for at least one of the first radio or the second radio. The first configuration may indicate a sleep mode configuration associated with at least one of (a) a first transmitter of the first radio associated with a first Uu connection, (b) a second transmitter of the first radio associated with a first sidelink connection, (c) a third transmitter of the first radio associated with the first Uu connection and the first sidelink connection, (d) a first receiver of the first radio associated with the first Uu connection, (e) a second receiver of the first radio associated with the first sidelink connection, (f) a third receiver of the first radio associated with the first Uu connection and the first sidelink connection, (g) a fourth transmitter of the second radio associated with a second Uu connection, (h) a fifth transmitter of the second radio associated with a second sidelink connection, (i) a sixth transmitter of the second radio associated with the second Uu connection and the second sidelink connection, (j) a fourth receiver of the second radio associated with the second Uu connection, (k) a fifth receiver of the second radio associated with the second sidelink connection, or (l) a sixth receiver of the second radio associated with the second Uu connection and the second sidelink connection.

Aspect 65 is the method of aspect 56, where the first signal may include an LP-WUS. The first configuration may indicate a wake-up mode configuration associated with at least one of (a) a first transmitter of the first radio associated with a first Uu connection, (b) a second transmitter of the first radio associated with a first sidelink connection, (c) a third transmitter of the first radio associated with the first Uu connection and the first sidelink connection, (d) a first receiver of the first radio associated with the first Uu connection, (e) a second receiver of the first radio associated with the first sidelink connection, (f) a third receiver of the first radio associated with the first Uu connection and the first sidelink connection, (g) a fourth transmitter of the second radio associated with a second Uu connection, (h) a fifth transmitter of the second radio associated with a second sidelink connection, (i) a sixth transmitter of the second radio associated with the second Uu connection and the second sidelink connection, (j) a fourth receiver of the second radio associated with the second Uu connection, (k) a fifth receiver of the second radio associated with the second sidelink connection, or (l) a sixth receiver of the second radio associated with the second Uu connection and the second sidelink connection.

Aspect 66 is the method of aspect 56, where the first signal may include at least one of an LP-WUS, LP-sync-preamble signal associated with the LP-WUS, an LP-RS, or an LP-SS. Communicating with the second radio at the UE may include communicating a second signal with the second radio at the UE. The first configuration may include at least one of (a) a cast type associated with communicating the second signal with the second radio, (b) a communication mode associated with communicating the second signal with the second radio, (c) a duplex mode associated with communicating the second signal with the second radio, (d) a service information associated with communicating the second signal with the second radio, (e) a device type associated with the UE, (f) a connection type associated with communicating the second signal with the second radio, (g) a CLI measurement associated with communicating the second signal with the second radio, or (h) a non-data service parameter associated with communicating the second signal with the second radio.

Aspect 67 is the method of aspect 66, where the cast type may include at least one of a unicast type, a broadcast type, or a multi-cast type.

Aspect 68 is the method of aspect 67, where the wake-up mode configuration may include an instruction for the UE to (a) receive a PDCCH scheduling the second signal, (b) select a QCL source and a TCI state for data communication associated with the cast type, (c) receive a CSI-RS associated with the cast type, (d) transmit the second signal using a CG resource, or (e) receive the second signal using an SPS resource.

Aspect 69 is the method of any of aspects 66 to 68, where the communication mode may include at least one of a transmission mode at the second radio, a reception mode at the second radio, or a transmission and reception mode at the second radio.

Aspect 70 is the method of aspect 69, where the transmission mode may include an UL mode associated with at least one of a Uu connection or a sidelink connection.

Aspect 71 is the method of either of aspects 69 or 70, where the reception mode may include a DL mode associated with at least one of a Uu connection or a sidelink connection.

Aspect 72 is the method of either of aspects 69 or 70, where the communication mode may include an UL only mode that deactivates at least one of an SW component, an FW component, an HW component, or an RF component associated with DL at the second radio.

Aspect 73 is the method of either of aspects 69 or 71, where the communication mode may include a DL only mode that deactivates at least one of an SW component, an FW component, an HW component, or an RF component associated with UL at the second radio.

Aspect 74 is the method of any of aspects 69, 70, or 72, where the communication mode may include an UL only mode that skips monitoring a PDCCH. The method may include receiving the second signal using a CG resource transmitted by the network node.

Aspect 75 is the method of any of aspects 66 to 74, where the duplex mode may include at least one of a half-duplex mode or a full-duplex mode.

Aspect 76 is the method of aspect 75, where the wake-up mode configuration may include an instruction for the UE to select a QCL source and a TCI state for data communication associated with the duplex mode. The wake-up mode configuration may include an instruction for the UE to select a slot format associated with the duplex mode.

Aspect 77 is the method of any of aspects 66 to 76, where the service information may include at least one of eMBB service information, URLLC service information, or XR service information.

Aspect 78 is the method of aspect 77, where the wake-up mode configuration may include an instruction for the UE to calculate a wakeup time based on a QoS requirement associated with the service information.

Aspect 79 is the method of aspect 78, where the QoS requirement may include at least one of a latency requirement, a bandwidth requirement, or a number of CCs requirement.

Aspect 80 is the method of any of aspects 66 to 79, where the device type may include at least one of a smart phone device type or a RedCap device type.

Aspect 81 is the method of any of aspects 66 to 80, where the non-data service parameter may include at least one of a sensing parameter or a positioning parameter.

Aspect 82 is the method of any of aspects 66 to 81, where the connection type may include at least one of a Uu connection type or a sidelink connection type.

Aspect 83 is the method of aspect 82, where the wake-up mode configuration may include an instruction for the UE to select at least one a QCL source, a TCI state, a tracking loop state, an AGC, or a reference signal associated with the connection type.

Aspect 84 is the method of aspect 56, where the second radio may have the lower power consumption than the first radio. Communicating with the first radio at the UE may include communicating with the first radio in an RRC connected mode. Communicating with the second radio at the UE may include at least one of (a) receiving a scheduling request from the second radio at the UE, (b) receiving HARQ feedback from the second radio at the UE for data received by the first radio at the UE, (c) receiving CSI from the second radio at the UE for a channel associated with the first radio at the UE, or (d) transmitting downlink or uplink scheduling information from the second radio at the UE for transmission or reception on the first radio.

Aspect 85 is the method of aspect 56, where the second radio may have the lower power consumption than the first radio. The method may include receiving a colliding transmission from the second radio at the UE if one or more collision rules for a first collision at the first radio indicates for the colliding transmission to be dropped.

Aspect 86 is the method of aspect 56, where the second radio may have the lower power consumption than the first radio. Communicating with the first radio at the UE may include transmitting a second signal to the first radio at the UE. Communicating with the second radio at the UE may include receiving a NACK associated with the second signal from the second radio at the UE.

Aspect 87 is the method of aspect 86, where the method may include transmitting a retransmission of the second signal to the second radio at the UE based on receiving the NACK associated with the second signal.

Aspect 88 is the method of aspect 87, where transmitting the retransmission of the second signal to the second radio may include transmitting the retransmission of the second signal in at least one of a first set of TB s larger than a second set of TB s associated with the second signal transmitted to the first radio or in a first period of time larger than a second period of time associated with the second signal transmitted to the first radio.

Aspect 89 is the method of aspect 56, where communicating with the first radio at the UE may include transmitting a second signal to the second radio at the UE. Communicating with the second radio at the UE may include transmitting a third signal to the first radio at the UE. The method may include receiving a multiplexed response from one of the first radio or the second radio. The multiplexed response may include a first response to the second signal multiplexed with a second response to the third signal.

Aspect 90 is the method of aspect 89, where the first response may include at least one of a HARQ-ACK or a CSI.

Aspect 91 is the method of aspect 54, where the second radio may have the lower power consumption than the first radio. Communicating with the second radio at the UE may include at least one of (a) receiving a schedule request, (b) receiving a HARQ-ACK associated with a second signal transmitted to the first radio or a third signal transmitted to the second radio, (c) receiving a CSI feedback signal associated with a fourth signal transmitted to the first radio, or (d) transmitting a scheduling grant for communication associated with the first radio.

Aspect 92 is the method of aspect 54, where the first radio may have the lower power consumption than the second radio. Communicating with the second radio at the UE may include transmitting an RS including a first clock configuration for a first clock associated with the first radio to the second radio at the UE.

Aspect 93 is the method of aspect 92, where the RS may include at least one of DCI, a MAC-CE, or an RRC configuration.

Aspect 94 is the method of either of aspects 92 or 93, where the method may include receiving a second signal including at least one parameter associated with the first clock from the second radio at the UE. The first clock configuration may be based on the at least one parameter.

Aspect 95 is the method of aspect 94, where the second signal may be at least one of an initial access message or a capability information message.

Aspect 96 is the method of either of aspects 94 or 95, where the at least one parameter associated with the first clock may include at least one of a frequency drift range or a clock schedule.

Aspect 97 is the method of aspect 96, where the frequency drift range may include at least one of an average frequency drift range or a maximum frequency drift range.

Aspect 98 is the method of aspect 97, where the at least one parameter may be associated with at least one of a clock type, an RRC state, or a power mode.

Aspect 99 is the method of any of aspects 92 to 98, where the RS may include a second clock configuration for a second clock associated with the first radio. The second clock may have at least a different accuracy or a different clock parameter than the first clock.

Aspect 100 is the method of any of aspects 92 to 98, where the method may include transmitting a second RS including a second clock configuration for a second clock via the second radio. The second clock may be associated with the first radio. The second clock may have at least a different accuracy or a different clock parameter than the first clock.

Aspect 101 is the method of any of aspects 54 to 100, where the method may include receiving a UE capability including a first indicator of at least one of a RedCap connection, an eRedCap connection, or a non-RedCap connection. The first signal may include at least one of an LP-WUS, an LP-RS, or an LP-SS including a second indicator to operate the second radio at the UE in a mode associated with the first indicator.

Aspect 102 is the method of aspect 56, where the second radio may have the lower power consumption than the first radio. Communicating with the first radio at the UE based on the second configuration transmitted to the first radio may include transmitting a set of cell IDs to the first radio. The cell IDs may include cell IDs of at least one neighbor cell and cell IDs of a serving cell.

Aspect 103 is the method of aspect 102, where transmitting the set of cell IDs to the first radio may include transmitting at least one of a PSS or an SSS to the first radio including the set of cell IDs.

Aspect 104 is the method of either of aspects 102 or 103, where the set of cell IDs may include a first cell ID associated with the first radio and a second cell ID associated with the second radio. The first radio may be different than the first radio. The first cell ID may be different from the second cell ID.

Aspect 105 is the method of aspect 104, where the first cell ID may be associated with a set of SSBs. The second cell ID may be associated with a set of LP signals.

Aspect 106 is an apparatus for wireless communication, including: a memory; and at least one processor coupled to the memory and, based at least in part on information stored in the memory, the at least one processor is configured to implement any of aspects 1 to 105.

Aspect 107 is the apparatus of aspect 106, further including at least one of an antenna or a transceiver coupled to the at least one processor.

Aspect 108 is an apparatus for wireless communication including means for implementing any of aspects 1 to 105.

Aspect 109 is a computer-readable medium (e.g., a non-transitory computer-readable medium) storing computer executable code, where the code when executed by a processor causes the processor to implement any of aspects 1 to 105.

What is claimed is:

1. An apparatus for wireless communication at a user equipment (UE), comprising:
a memory; and
at least one processor coupled to the memory and, based at least in part on information stored in the memory, the at least one processor is configured to:
receive a first signal comprising a first configuration using a first radio at the UE; and
operate a second radio at the UE in a first mode based on the first configuration received via the first radio, wherein the first radio has a lower power consumption than the second radio or the second radio has the lower power consumption than the first radio.

2. The apparatus of claim 1, wherein the at least one processor is further configured to:
configure the first radio based on a second configuration, wherein the first signal comprises the second configuration; and
operate the first radio at the UE in a second mode based on the second configuration received via the first radio, wherein, to operate the first radio at the UE in the second mode and to operate the second radio at the UE in the first mode, the at least one processor is configured to simultaneously communicate a second signal at the first radio and communicate a third signal at the second radio during a first time period, wherein, to simultaneously communicate the second signal at the first radio and communicate the third signal at the second radio, the at least one processor is configured to:
communicate the second signal using a first set of resources and communicate the third signal using a second set of resources during the first time period, wherein the first set of resources are non-overlapping with and non-adjacent with the second set of resources; or
multiplex the second signal and the third signal via time domain multiplexing (TDM) to communicate the second signal during a first set of time periods and communicate the third signal during a second set of time periods, wherein the first time period comprises the first set of time periods and the second set of time periods.

3. The apparatus of claim 1, wherein the at least one processor is further configured to:
configure the first radio based on a second configuration, wherein the first signal comprises the second configuration; and
operate the first radio at the UE in a second mode based on the second configuration received via the first radio, wherein, to operate the first radio at the UE in the second mode and to operate the second radio at the UE in the first mode, the at least one processor is configured to simultaneously communicate a second signal at the first radio and communicate a third signal at the second radio during a first time period, wherein the first signal comprises at least one of a low-power (LP) wake-up signal (LP-WUS), a low-power reference signal (LP-RS) or a low-power synchronization signal (LP-SS), wherein the first configuration comprises at least one of:
a minimum time threshold for the UE to switch between operating the first radio at the UE in the second mode and operating the second radio at the UE in the first mode;
a first physical downlink control channel (PDCCH) occasion indicator associated with the first radio and a second PDCCH occasion indicator associated with the second radio;
a first slot format associated with the first radio and a second slot format associated with the second radio; or
a first signal type associated with the first radio and a second signal type associated with the second radio.

4. The apparatus of claim 1, wherein the at least one processor is further configured to:
configure the first radio based on a second configuration, wherein the first signal comprises the second configuration; and
operate the first radio at the UE in a second mode based on the second configuration received via the first radio, wherein, to operate the first radio at the UE in the second mode, the at least one processor is configured to communicate a second signal at the first radio using a universal mobile telecommunications system (UMTS) air interface (Uu) connection, wherein, to operate the second radio at the UE in the first mode, the at least one processor is configured to communicate a third signal at the second radio using a sidelink connection.

5. The apparatus of claim 1, wherein the at least one processor is further configured to:
configure the first radio based on a second configuration, wherein the first signal comprises the second configuration;
operate the first radio at the UE in a second mode based on the second configuration received via the first radio; and
transmit a UE capability to a network node, wherein the UE capability comprises an indicator of a transition time between operating the first radio and operating the second radio, wherein a schedule associated with the first configuration and the second configuration is based on the indicator.

6. The apparatus of claim 1, wherein the at least one processor is further configured to:
configure the first radio based on a second configuration, wherein the first signal comprises the second configuration; and
operate the first radio at the UE in a second mode based on the second configuration received via the first radio, wherein the first signal comprises a low-power (LP) wake-up signal (LP-WUS), wherein the first configuration indicates a wake-up mode configuration associated with at least one of:
a first transmitter of the first radio associated with a first universal mobile telecommunications system (UMTS) air interface (Uu) connection;
a second transmitter of the first radio associated with a first sidelink connection;
a third transmitter of the first radio associated with the first Uu connection and the first sidelink connection;
a first receiver of the first radio associated with the first Uu connection;
a second receiver of the first radio associated with the first sidelink connection;
a third receiver of the first radio associated with the first Uu connection and the first sidelink connection;
a fourth transmitter of the second radio associated with a second Uu connection;
a fifth transmitter of the second radio associated with a second sidelink connection;
a sixth transmitter of the second radio associated with the second Uu connection and the second sidelink connection;
a fourth receiver of the second radio associated with the second Uu connection;
a fifth receiver of the second radio associated with the second sidelink connection; or
a sixth receiver of the second radio associated with the second Uu connection and the second sidelink connection.

7. The apparatus of claim 1, wherein the at least one processor is further configured to:
configure the first radio based on a second configuration, wherein the first signal comprises the second configuration; and
operate the first radio at the UE in a second mode based on the second configuration received via the first radio, wherein the first signal comprises at least one of a low-power (LP) wake-up signal (LP-WUS), a low-power reference signal (LP-RS) or a low-power synchronization signal (LP-SS), wherein, to operate the second radio at the UE in the first mode, the at least one processor is configured to communicate a second signal at the second radio, wherein the first configuration comprises at least one of:
a cast type associated with communicating the second signal at the second radio;
a communication mode associated with communicating the second signal at the second radio;
a duplex mode associated with communicating the second signal at the second radio;
a service information associated with communicating the second signal at the second radio;
a device type associated with the UE;
a connection type associated with communicating the second signal at the second radio;
a cross-link interference (CLI) measurement associated with communicating the second signal at the second radio; or
a non-data service parameter associated with communicating the second signal at the second radio.

8. The apparatus of claim 1, wherein the at least one processor is further configured to:
configure the first radio based on a second configuration, wherein the first signal comprises the second configuration; and
operate the first radio at the UE in a second mode based on the second configuration received via the first radio, wherein the second radio has the lower power consumption than the first radio, wherein, to operate the first radio at the UE in the second mode, the at least one processor is configured to communicate in a radio resource control (RRC) connected mode via the first radio, wherein, to operate the second radio at the UE in the first mode, the at least one processor is configured to:
transmit a scheduling request via the second radio,
transmit hybrid automatic repeat request (HARQ) feedback via the second radio for data received on the first radio,
transmit channel state information (CSI) via the second radio for a channel associated with the first radio, or
receive downlink or uplink scheduling information via the second radio for transmission or reception on the first radio.

9. The apparatus of claim 1, wherein the at least one processor is further configured to:
configure the first radio based on a second configuration, wherein the first signal comprises the second configuration;
operate the first radio at the UE in a second mode based on the second configuration received via the first radio, wherein the second radio has the lower power consumption than the first radio, wherein, to operate the first radio at the UE in the second mode, the at least one processor is configured to receive a second signal via the first radio, wherein, to operate the second radio at the UE in the first mode, the at least one processor is configured to transmit a negative acknowledgement (NACK) associated with the second signal via the second radio; and
receive a retransmission of the second signal via the second radio in at least one of a first set of transmission blocks (TBs) larger than a second set of TBs associated with the second signal received via the first radio or a first period of time larger than a second period of time associated with the second signal received via the first radio.

10. The apparatus of claim 1, wherein the at least one processor is further configured to:
configure the first radio based on a second configuration, wherein the first signal comprises the second configuration;
operate the first radio at the UE in a second mode based on the second configuration received via the first radio, wherein, to operate the first radio at the UE in the second mode, the at least one processor is configured to receive a second signal via the second radio, wherein, to operate the second radio at the UE in the first mode, the at least one processor is configured to receive a third signal via the first radio;
multiplex a first response to the second signal with a second response to the third signal to generate a multiplexed response, wherein at least one of the first response or the second response comprises at least one of a hybrid automatic repeat request (HARQ) acknowledgement (HARQ-ACK) or a channel state information (CSI); and
transmit the multiplexed response via one of the first radio or the second radio.

11. The apparatus of claim 1, wherein the second radio has the lower power consumption than the first radio, wherein, to operate the second radio at the UE in the first mode, the at least one processor is configured to:
transmit a schedule request;
transmit a hybrid automatic repeat request (HARQ) acknowledgement (HARQ-ACK) associated with a second signal received by the first radio or a third signal received by the second radio;
transmit a channel state information (CSI) associated with a fourth signal received by the first radio; or
receive a scheduling grant for communication associated with the first radio.

12. The apparatus of claim 1, further comprising a transceiver coupled to the at least one processor, wherein the first radio has the lower power consumption than the second radio, wherein, to operate the second radio at the UE in the first mode, the at least one processor is configured to:
receive, via the transceiver, a reference signal (RS) comprising a first clock configuration via the second radio; and
configure a first clock associated with the first radio based on the first clock configuration.

13. The apparatus of claim 12, wherein, to configure the first clock associated with the first radio based on the first clock configuration, the at least one processor is configured to:
track a configuration time associated with the first clock configuration;
track a configuration frequency associated with the first clock configuration;
synchronize a time associated with the first clock based on the configuration time associated with the first clock configuration;
synchronize a frequency associated with the first clock based on the configuration frequency associated with the first clock configuration;
correct the time associated with the first clock based on a time estimation error calculated based on the first clock configuration;
correct the frequency associated with the first clock based on a frequency estimation error calculated based on the first clock configuration; or
estimate a channel at the first radio based on the first clock configuration.

14. The apparatus of claim 1, wherein the at least one processor is further configured to:
transmit a UE capability comprising a first indicator of at least one of a RedCap connection, an eRedCap connection, or a non-RedCap connection, wherein the first signal comprises at least one of a low-power (LP) wake-up signal (LP-WUS), a low-power-synchronization-preamble signal (LP-sync-preamble signal), a low-power reference signal (LP-RS) or a low-power synchronization signal (LP-SS) comprising a second indicator to operate the second radio at the UE in the first mode, wherein the first mode is associated with the first indicator.

15. An apparatus for wireless communication at a network node, comprising:
a memory; and
at least one processor coupled to the memory and, based at least in part on information stored in the memory, the at least one processor is configured to:
transmit a first signal comprising a first configuration for a second radio to a first radio at a user equipment (UE); and
communicate with the second radio at the UE based on the first configuration transmitted to the first radio, wherein the first radio has a lower power consumption than the second radio or the second radio has the lower power consumption than the first radio.

16. The apparatus of claim 15, wherein the first signal further comprises a second configuration for the first radio, wherein the at least one processor is further configured to:
communicate with the first radio at the UE based on the second configuration transmitted to the first radio, wherein, to communicate with the first radio at the UE and communicate with the second radio at the UE, the at least one processor is configured to:
simultaneously communicate a second signal with the first radio and communicate a third signal with the second radio during a first time period, wherein, to simultaneously communicate the second signal at the first radio and communicate the third signal at the second radio, the at least one processor is configured to:
communicate the second signal using a first set of resources and communicate the third signal using a second set of resources during the first time period, wherein the first set of resources are non-overlapping with and non-adjacent with the second set of resources; or
multiplex the second signal and the third signal via time domain multiplexing (TDM) to communicate the second signal during a first set of time periods and communicate the third signal during a second set of time periods, wherein the first time period comprises the first set of time periods and the second set of time periods.

17. The apparatus of claim 15, wherein the first signal further comprises a second configuration for the first radio, wherein the at least one processor is further configured to:
communicate with the first radio at the UE based on the second configuration transmitted to the first radio, wherein, to communicate with the first radio at the UE and communicate with the second radio at the UE, the at least one processor is configured to simultaneously communicate a second signal with the first radio and communicate a third signal with the second radio during a first time period; and
receive a UE capability from the UE, wherein the UE capability comprises an indicator of a simultaneous connectivity capability that indicates at least one of an identifier of the UE, a common set of bands, or a common set of component carriers (CCs), wherein, to simultaneously communicate the second signal with the first radio and communicate the third signal with the second radio, the at least one processor is configured to simultaneously communicate the second signal with the first radio and communicate the third signal with the second radio based on the UE capability.

18. The apparatus of claim 15, further comprising a transceiver coupled to the at least one processor, wherein the first signal further comprises a second configuration for the first radio, wherein the at least one processor is further configured to:
communicate with the first radio at the UE via the transceiver based on the second configuration transmitted to the first radio; and
receive a UE capability from the UE, wherein the UE capability comprises an indicator of a transition time between a first operation of the first radio and a second operation of the second radio, wherein a schedule associated with the first configuration and the second configuration is based on the indicator.

19. The apparatus of claim 15, wherein the first signal comprises a second configuration for the first radio, wherein the at least one processor is further configured to:
communicate with the first radio at the UE based on the second configuration transmitted to the first radio, wherein the first signal comprises a low-power (LP) wake-up signal (LP-WUS) further comprising a second configuration for the first radio; and
communicate with the first radio at the UE based on the second configuration transmitted to the first radio, wherein the first configuration indicates a wake-up mode configuration associated with at least one of:
a first transmitter of the first radio associated with a first universal mobile telecommunications system (UMTS) air interface (Uu) connection;
a second transmitter of the first radio associated with a first sidelink connection;
a third transmitter of the first radio associated with the first Uu connection and the first sidelink connection;
a first receiver of the first radio associated with the first Uu connection;
a second receiver of the first radio associated with the first sidelink connection;
a third receiver of the first radio associated with the first Uu connection and the first sidelink connection;
a fourth transmitter of the second radio associated with a second Uu connection;
a fifth transmitter of the second radio associated with a second sidelink connection;
a sixth transmitter of the second radio associated with the second Uu connection and the second sidelink connection;
a fourth receiver of the second radio associated with the second Uu connection;
a fifth receiver of the second radio associated with the second sidelink connection; or
a sixth receiver of the second radio associated with the second Uu connection and the second sidelink connection.

20. The apparatus of claim 15, wherein the first signal comprises a second configuration for the first radio, wherein the at least one processor is further configured to:
communicate with the first radio at the UE based on the second configuration transmitted to the first radio, wherein the first signal comprises at least one of a low-power (LP) wake-up signal (LP-WUS), a low-power-synchronization-preamble signal (LP-sync-preamble signal), a low-power reference signal (LP-RS) or a low-power synchronization signal (LP-SS), wherein, to communicate with the second radio at the UE, the at least one processor is configured to communicate a second signal with the second radio at the UE, wherein the first configuration comprises at least one of:
a cast type associated with communicating the second signal with the second radio;
a communication mode associated with communicating the second signal with the second radio;
a duplex mode associated with communicating the second signal with the second radio;
a service information associated with communicating the second signal with the second radio;
a device type associated with the UE;
a connection type associated with communicating the second signal with the second radio;
a cross-link interference (CLI) measurement associated with communicating the second signal with the second radio; or
a non-data service parameter associated with communicating the second signal with the second radio.

21. The apparatus of claim 15, wherein the first signal comprises a second configuration for the first radio, wherein the at least one processor is further configured to:
communicate with the first radio at the UE based on the second configuration transmitted to the first radio, wherein the second radio has the lower power consumption than the first radio; and:
receive a colliding transmission from the second radio at the UE if one or more collision rules for a first collision at the first radio indicates for the colliding transmission to be dropped.

22. The apparatus of claim 15, wherein the first signal comprises a second configuration for the first radio, wherein the at least one processor is further configured to:
communicate with the first radio at the UE based on the second configuration transmitted to the first radio, wherein the second radio has the lower power consumption than the first radio, wherein, to communicate with the first radio at the UE, the at least one processor is configured to transmit a second signal to the first radio at the UE, wherein, to communicate with the second radio at the UE, the at least one processor is configured to receive a negative acknowledgement (NACK) associated with the second signal from the second radio at the UE; and
transmit a retransmission of the second signal to the second radio at the UE in at least one of a first set of transmission blocks (TBs) larger than a second set of TBs associated with the second signal transmitted to the first radio or a first period of time larger than a second period of time associated with the second signal transmitted to the first radio based on receiving the NACK associated with the second signal.

23. The apparatus of claim 15, wherein the first signal comprises a second configuration for the first radio, wherein the at least one processor is further configured to:
communicate with the first radio at the UE based on the second configuration transmitted to the first radio, wherein, to communicate with the first radio at the UE, the at least one processor is configured to transmit a second signal to the second radio at the UE, wherein, to communicate with the second radio at the UE, the at least one processor is configured to transmit a third signal to the first radio at the UE; and
receive a multiplexed response from one of the first radio or the second radio, wherein the multiplexed response comprises a first response to the second signal multiplexed with a second response to the third signal, wherein the first response comprises at least one of a hybrid automatic repeat request (HARQ) acknowledgement (HARQ-ACK) or a channel state information (CSI).

24. The apparatus of claim 15, wherein the second radio has the lower power consumption than the first radio, wherein, to communicate with the second radio at the UE, the at least one processor is configured to:
receive a schedule request;
receive a hybrid automatic repeat request (HARQ) acknowledgement (HARQ-ACK) associated with a second signal transmitted to the first radio or a third signal transmitted to the second radio;
receive a channel state information (CSI) feedback signal associated with a fourth signal transmitted to the first radio; or
transmit a scheduling grant for communication associated with the first radio.

25. The apparatus of claim 15, wherein the first radio has the lower power consumption than the second radio, wherein, to communicate with the second radio at the UE, the at least one processor is configured to:
transmit a reference signal (RS) comprising a first clock configuration for a first clock associated with the first radio to the second radio at the UE.

26. The apparatus of claim 25, wherein the RS comprises a second clock configuration for a second clock associated with the first radio, wherein the second clock has at least a different accuracy or a different clock parameter than the first clock.

27. The apparatus of claim 25, wherein the at least one processor is further configured to:
transmit a second RS comprising a second clock configuration for a second clock via the second radio, wherein the second clock is associated with the first radio, wherein the second clock has at least a different accuracy or a different clock parameter than the first clock.

28. The apparatus of claim 15, wherein the at least one processor is further configured to:
receive a UE capability comprising a first indicator of at least one of a RedCap connection, an eRedCap connection, or a non-RedCap connection, wherein the first signal comprises at least one of a low-power (LP) wake-up signal (LP-WUS), a low-power-synchronization-preamble signal (LP-sync-preamble signal), a low-power reference signal (LP-RS) or a low-power synchronization signal (LP-SS) comprising a second indicator to operate the second radio at the UE in a mode associated with the first indicator.

29. A method of wireless communication at a user equipment (UE), comprising:
receiving a first signal comprising a first configuration using a first radio at the UE; and
operating a second radio at the UE in a first mode based on the first configuration received via the first radio, wherein the first radio has a lower power consumption than the second radio or the second radio has the lower power consumption than the first radio.

30. A method of wireless communication at a network node, comprising:
transmitting a first signal comprising a first configuration for a second radio to a first radio at a user equipment (UE); and
communicating with the second radio at the UE based on the first configuration transmitted to the first radio, wherein the first radio has a lower power consumption than the second radio or the second radio has the lower power consumption than the first radio.
